(19) United States
(12) Patent Application Publication
(10) Pub. No.: US 2026/0072992 A1
(43) Pub. Date: Mar. 12, 2026

(54) ADAPTIVE DOCUMENT INTEGRATION USING GENERATIVE ARTIFICIAL INTELLIGENCE

(71) Applicant: Oracle International Corporation, Redwood Shores, CA (US)

(72) Inventors: Yan Wang, Redwood City, CA (US); Yiye Zeng, Redwood City, CA (US); Rondy Ng, Redwood City, CA (US); Harshavardhan Takle, Foster City, CA (US); Kavin Kumar Kuppusamy, Redwood City, CA (US); Kishore Kondepudi, Pleasanton, CA (US)

(73) Assignee: Oracle International Corporation, Redwood Shores, CA (US)

(21) Appl. No.: 19/169,134

(22) Filed: Apr. 3, 2025

Related U.S. Application Data
(60) Provisional application No. 63/691,584, filed on Sep. 6, 2024.

(51) Int. Cl. G06F 16/93; G06F 16/25

(52) U.S. Cl. CPC G06F 16/93; G06F 16/25

(57) ABSTRACT

Systems, methods, and computer-readable media are provided for using generative AI enriched with metadata about historical document characteristics to transform documents of various formats, including images, to the fields and values they represent. A prompt template may be selected in association with a type of document. The prompt template indicates field definition(s) of field(s) to be detected in the document and location(s) in which the field(s) have been detected in prior documents. A large language model is prompted with a prompt generated using the prompt template to generate a result that assigns value(s) to the field(s). Output from the language model is used for identifying the field to value mapping for the document, such that data detected from the document may be stored in appropriate database structures of a database. Metadata stored in association with the prompt template is updated based on location(s) in the document in which the field(s) were detected, and the value(s) of the field(s) are stored in a database. Outbound documents may be similarly translated to detect values of corresponding fields requested by third parties, even if those values are not stored in the database. In this scenario, values for fields may be detected in outbound documents using the prompt templates enriched with metadata as processed by the large language model before such information is prepared to be sent to a third party.

### CROSS REFERENCE OF RELATED APPLICATIONS

This application claims the benefit of U.S. Provisional Patent Application No. 63/691,584, filed on Sep. 6, 2024, the entire disclosure of which is incorporated by reference herein in its entirety for all purposes.

### BACKGROUND

Companies exchange documents such as invoices, receipts, requests, and statements, to manage outstanding liabilities or obligations, and/or to keep track of each company's activities with respect to other companies. Even within a company, documents may be uploaded as documented evidence, for example, when reimbursement requests are submitted. Different divisions of a company may exchange documents with each other for keeping track of company activities.

### BRIEF SUMMARY

Various embodiments described herein cover adaptive document integration using generative artificial intelligence. Such techniques can be used for transaction automation with trading partners in any electronic channels, formats, and languages using generative artificial intelligence (AI). In some embodiments, a computer-implemented method includes using generative AI enriched with metadata about historical document characteristics to transform documents of various formats, including images, to the fields and values they represent. The fields and values may then be stored in underlying database structures in a database. The method comprises selecting a prompt template associated with a type of document. The prompt template indicates field definition(s) of field(s) to be detected in the document and location(s) in which the field(s) have been detected in prior documents. A large language model is prompted with a prompt generated using the prompt template to generate a result that assigns value(s) to the field(s). Metadata stored in association with the prompt template is updated based on location(s) in the document in which the field(s) were detected, and the value(s) of the field(s) are stored in a database.

In one embodiment, a computer-implemented method includes receiving a document representing content comprising text. The computer-implemented method further includes determining a type of the document based at least in part on similarities between a first plurality of values of a plurality of features of the text and other pluralities of values of the plurality of features stored in association with types of documents. Metadata is stored in association with the type of document to indicate where in the type of document certain fields of text have been detected. The computer-implemented method further includes selecting a prompt template associated with the type of the document, and generating a prompt comprising the text, one or more field definitions for two or more fields to be detected in the text, one or more indications, based on the metadata, indicating where in the type of document values for at least one of the two or more fields have been historically detected, and a requested structured format of a result. The computer-implemented method further includes prompting a large language model with the prompt, and receiving a particular result of the prompt, wherein particular values for the two or more fields are included in the requested structured format of the particular result. The computer-implemented method further includes determining where, in the text, at least one particular value of the at least one of the two or more fields were detected. The computer-implemented method further includes updating the metadata based at least in part on where, in the text, the at least one particular value was detected, and storing the particular values for the two or more fields in one or more data structures, optionally in association with the document.

In a further embodiment, other types of documents are associated with other prompt templates that each include at least one field definition different than the one or more field definitions.

In the same or a different further embodiment, the computer-implemented method includes receiving input that indicates another location, in the document, that another particular value is detected. The other particular value is labeled as a corrected replacement of the at least one particular value. The computer-implemented method further includes updating the metadata based at least in part on the other location.

In the same or a different further embodiment, determining the type of the document comprises determining cosine distances between the first plurality of values of a plurality of features of the text and other pluralities of values of the plurality of features stored in association with types of documents.

In the same or a different further embodiment, determining the type of the document comprises prompting a large language model using a document type template to generate a document type prompt. The document type prompt specifies the types of documents and includes the text. The computer-implemented method further includes receiving a document type response to the document type prompt. The document type response comprises the type of the document.

In the same or a different further embodiment, at least one type of document of the types of documents is specific to an entity that originated the document.

In the same or a different further embodiment, the prompt and the metadata indicate where, in the document, the values for the at least one field have been historically detected based at least in part on a specified marker that was detected in historical documents.

In the same or a different further embodiment, the prompt and the metadata indicate where, in the document, the values for the at least one field have been historically detected based at least in part on a specified section that was detected in historical documents.

In the same or a different further embodiment, the computer-implemented method includes causing concurrent display of the document and the at least one particular value in a user interface. The at least one particular value is selectable to cause navigation in the document to a location where the at least one particular value was detected. In a further embodiment, the computer-implemented method includes receiving user input on the document marking another location in the particular document for the at least one particular value, wherein the other location is used to update the metadata.

In the same or a different further embodiment, the document is received as an attachment to an email or is received via a Short Message Service text message.

In the same or a different further embodiment, the computer-implemented method includes initiating a downstream workflow for the document based at least in part on the at least one particular value of the at least one of the two or more fields satisfying a stored condition.

In the same or a different further embodiment, at least determining the type of the document is performed by a first agent in a multi-agent system that supports communication between agents and communication between individual agents and one or more large language models. At least generating the prompt is performed by a second agent in the multi-agent system. The computer-implemented method further includes selecting the second agent from among a plurality of candidate agents based at least in part on the type of the document.

In the same or a different further embodiment, at least determining the type of the document is performed by a first agent in a multi-agent system that supports communication between agents and communication between individual agents and one or more large language models. At least generating the prompt is performed by a second agent in the multi-agent system. The computer-implemented method further includes selecting the second agent from among a plurality of candidate agents based at least in part on an entity detected in the document.

In the same or a different further embodiment, at least determining the type of the document is performed by a first agent in a multi-agent system that supports communication between agents and communication between individual agents and one or more large language models. At least generating the prompt is performed by a second agent in the multi-agent system. The computer-implemented method further includes selecting the second agent from among a plurality of candidate agents that are available to handle the type of the document based at least in part on a formatted section detected in the document.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that uses generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s).

FIG. 2 illustrates a system diagram showing an example system that uses generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s).

FIG. 3 illustrates a diagram of an example user interface concurrently showing a selected field and value as well as where, in the document, the value for the selected field was detected.

FIGS. 4A and 4B illustrate system diagrams showing example systems 400A and 400B that use generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s).

FIG. 5 illustrates a flow for an example onboarding one or more tenants to a document integration system.

FIG. 6 illustrates a flow for an example of using generative AI enriched with metadata about historical document characteristics to transform documents of various formats, including images, to the fields and values they represent, for example, by processing of documents to detect location(s) of value(s) of field(s) in the document(s) and updating prompt template(s) accordingly.

FIG. 7 illustrates an example document in another language that may be processed according to the techniques described herein to use generative AI enriched with metadata about historical document characteristics to transform documents of various formats to the fields and values they represent, for example, by detecting location(s) of value(s) of field(s) in the document and updating prompt template(s) accordingly.

FIG. 8 illustrates an example interface showing detected fields, detected translations of fields, detected values of the fields, and a summary of the document based on the detected values.

FIG. 9 illustrates an example interface showing a pipeline of documents that have been processed or partially processed by the document integration system.

FIG. 10 illustrates an example interface showing a particular unstructured document that has been processed or partially processed by the document integration system.

FIG. 11 illustrates an example interface showing a particular structured document that has been processed or partially processed by the document integration system.

FIG. 12 illustrates an example interface showing a notification about incoming documents for which user review is requested.

FIG. 13 illustrates an example user interface concurrently showing a selected field and value as well as where, in the document, the value for the selected field was detected.

FIG. 14 illustrates an example user interface concurrently showing another selected field and value as well as where, in the document, the value for the other selected field was detected.

FIG. 15 illustrates an example user interface showing a request for a document in a specific format.

FIG. 16 illustrates a user interface showing a document automatically generated in the specific format available for output.

FIG. 17 depicts a simplified diagram of a distributed system for implementing certain aspects.

FIG. 18 is a simplified block diagram of one or more components of a system environment by which services provided by one or more components of an embodiment system may be offered as cloud services, in accordance with certain aspects.

FIG. 19 illustrates an example computer system that may be used to implement certain aspects.

### DETAILED DESCRIPTION

An adaptive and intelligent document integration system is provided for using generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s). A description of the intelligent document integration system is provided in the following sections:
MATCHING INCOMING DOCUMENTS TO DOCUMENT CATEGORIES
SELECTING AND CONFIGURING A PROMPT TEMPLATE FOR PROMPTING AN LLM
SELECTING AN LLM TO PROCESS PROMPT TEMPLATES
PROMPTING THE LLM TO FIND VALUE(S) OF FIELD(S) IN THE DOCUMENT
INTEGRATING A RESULT FOM THE LLM INTO THE DATABASE
UPDATING METADATA FOR THE DOCUMENT CATEGORY TO IMPROVE THE PROMPT TEMPLATE(S)
OUTBOUND DOCUMENT TRANSFORMATION
PROCESS AUTOMATION FROM INGESTED DOCUMENT DATA
AUTOMATICALLY GENERATED DOCUMENT PROCESSING WORKFLOWS
EXAMPLE PROMPT TEMPLATES AND LLM RESPONSES
EXAMPLE EMBODIMENTS AND FEATURES
EXAMPLE DOCUMENT TYPES
AGENT-BASED DOCUMENT INTAKE ARCHITECTURE
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Generative artificial intelligence (Gen AI, such as that offered by large language models (LLMs)) based automation dramatically simplifies onboarding and transaction integration complexities of trading partners such as customers, suppliers, banks, government authorities, logistics providers, etc. Generative artificial intelligence can simplify the document intake process by promoting a more seamless, immediate, efficient, and accurate integration of documents (e.g., invoices, receipts, requests, and statements) with a target database, with appropriate values from the documents stored in corresponding database structures, that does not rely on human expertise and effort. Document IO enables automation over all transaction inflow and outflow complexities with varying electronic channels, document standards, formats, and even languages. Without the techniques described herein, bulk document intake would require a significant amount of human expertise and effort, and machine-driven processes for document intake would not be able to accurately, reliably, and sufficiently integrate documents into target database structures of a database.

Document IO (inbound/outbound) accepts business documents in any language, from various trading partners and customers in their own formats (public standards like UBL (Universal Business Language)/OAG (Open Applications Group) or supplier specific formats) via channels like emails, files over REST (Representational State Transfer), XML (extensible markup language) or JSON (JavaScript Object Notation) over REST or Streams. Using generative AI, Document IO recognizes and transforms these documents into ERP-compatible schema and orchestrates internal processes for seamless transaction processing through the ERP (enterprise resource planning) lifecycle without manual intervention by customers or business users. It also generates outbound documents like payment instructions or remittance advice in formats accepted by banks or sellers, eliminating the need for external transformations. Document IO leverages public formats such as OAG and UBL, known transformation mappings and Oracle ERP document specifications as RAG (retrieval augmented generation) sources, for example, from a vector database, to accurately recognize and extract data elements from documents. It incorporates a unique document fingerprint-driven adaptive learning system to continuously refine its processes based on feedback and evolving document characteristics.

In various embodiments, RAG is used to enrich generative artificial intelligence output by integrating a large language model with an information retrieval and prompt enrichment pipeline. The information retrieval and prompt enrichment pipeline pull in relevant details from a data store to provide additional context to the large language model. This additional context is used for improving the ability and accuracy of the large language model to detect which value(s) for which field(s) are present in the text of the document. RAG retrieves information from data sources in real-time as the document is processed to enrich a prompt to the large language model for generating a proposed set of value(s) of field(s) detected in the document.

In one embodiment, the database may include elastic search and/or semantic search features that allow related field(s) to be pulled in from the database. The elastic search and/or semantic search may be used to match incoming data sources, document types, or other available characteristics with details about which field(s) and corresponding value(s) are often detected in documents having those characteristics. In one embodiment, Oracle Vector Database is used to match characteristics of incoming documents with existing datasets stored in the database based on precomputing vector embeddings of the characteristics of the existing datasets. A vector embedding of the incoming documents may be compared against the precomputed vector embeddings of the characteristics of the existing datasets to determine a closest vector embedding and a closest matching schema, for example, using cosine distance between the vector embeddings.

In one embodiment, the information retrieved and used to enrich the large language model prompt includes information about a field to detect and how the field maps to an underlying data format or schema of a structured data source, such as an underlying database. The data format or schema of the underlying database may be dynamically retrieved as the document is being processed to enrich the prompt to the large language model and help the large language model accurately find value(s) for field(s) in the document. In addition to supplying the data structure or schema, the embodiments described herein may enrich the prompt with candidate values or value sets that are available for specific field(s) identified, such as value sets from drop-down menus. In another embodiment, specific value(s) of field(s) detected in the document may be used to retrieve further information that may be used to further enrich a prompt template in another round of processing the document by the large language model. In one example, a merchant category code (MCC) for an incoming document may be used as a RAG source used to enrich the prompt to the large language model to help derive additional expense type details.

This approach enhances operational efficiency and accuracy, eliminating any external data transformations by partners or customers, automated data exchanges that meet individual customer needs and improve overall business integration.

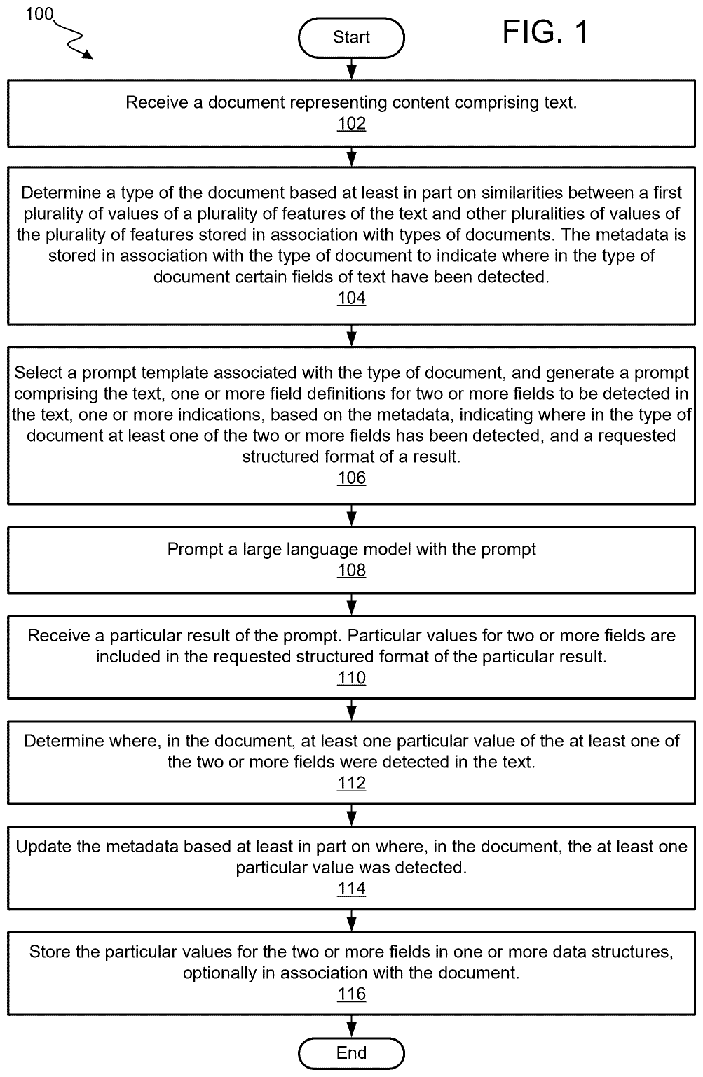

FIG. 1 illustrates a flow chart of an example process 100 that uses generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s). Process 100 starts with block 102, where a document is received. The document represents content comprising text. For example, the document may include images, structured data, pdf documents, or any other type or format of document from which text can be ascertained through official character recognition (OCR) or by other means. In various embodiments, the document may also be an audio, video, or audiovisual file from which text can be ascertained through speech-to-text translation or OCR.

In block 104, a document integration system determines a type of the document based at least in part on similarities between a first plurality of values of a plurality of features of the text and other pluralities of values of the plurality of features stored in association with types of documents. The metadata is stored in association with the type of document to indicate where in the type of document certain fields of text have been detected. In block 106, the document integration system selects a prompt template associated with the type of document, and generate a prompt comprising the text, one or more field definitions for two or more fields to be detected in the text, one or more indications, based on the metadata, indicating where in the type of document at least one of the two or more fields has been detected, and a requested structured format of a result. In block 108, the document integration system prompts a large language model with the prompt. In block 110, the document integration system receives a particular result of the prompt. Particular values for two or more fields are included in the requested structured format of the particular result. In block 112, the document integration system determines where, in the text, at least one particular value of the at least one of the two or more fields were detected. In block 114, the metadata is updated based at least in part on where, in the text, the at least one particular value was detected. The update to the metadata may be informed by user feedback as provided on the location of the at least one particular value, and/or may be informed by feedback from the document integration system based on matching or partially matching values in one or more records used in or associated with further processing or further ingesting of the corresponding document (for example, based on an accuracy of the at least one particular value in comparison with item(s) in the one or more records), or may be based on the results from the LLM without user feedback. The particular values may be stored for the two or more fields in one or more data structures, such as corresponding records or dimensions where the fields exist. The particular values may be stored in association with the document to facilitate review of the document as the particular values are reviewed or analyzed.

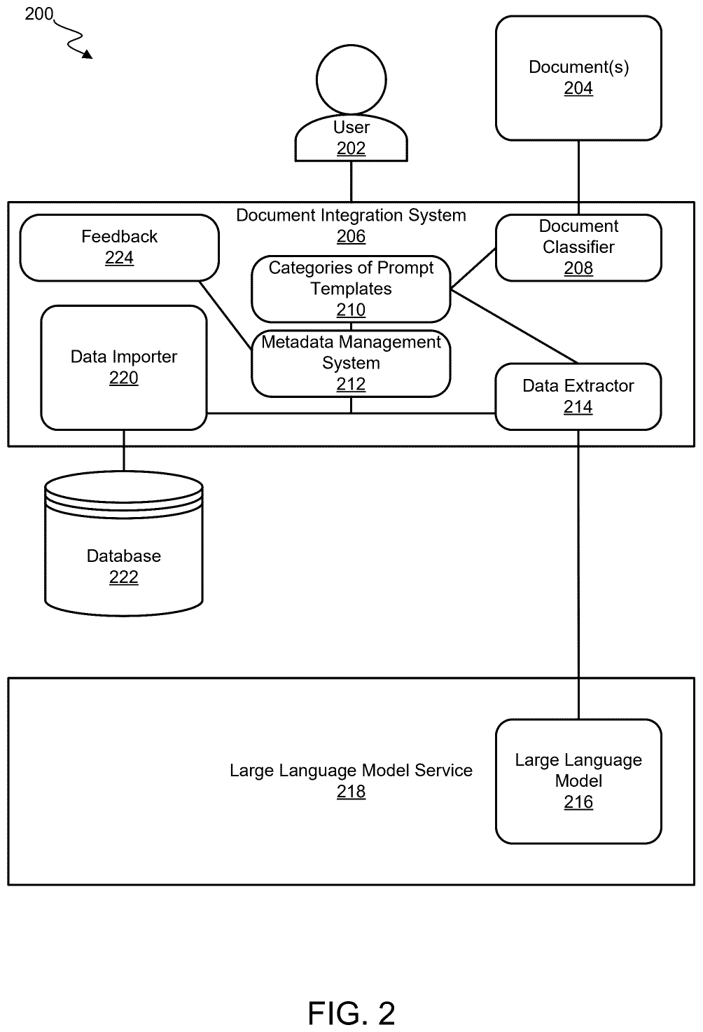

FIG. 2 illustrates a system diagram showing an example system 200 that uses generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s). As shown, user 202 interacts with document integration system 206 to review a document(s) 204 that has been ingested into document integration system 206 by user 202 or by another user or system. Document integration system 206 uses document classifier 208 to classify document(s) 204 into a category of the categories of prompt templates 210. A selected prompt template in the corresponding category is used by data extractor 214 to prompt large language model 216 of large language model service 218. The prompt may include hints specific to the corresponding category that help large language model 216 accurately locate value(s) for field(s) requested to be identified in the prompt. A result from the large language model 216 may be fed back into metadata management system 212 to improve future hints. User 202 may alternatively or additionally provide feedback 224 on the results to metadata management system 212 to improve future hints. The result may alternatively or additionally be fed to data importer 220, which updates database structures in database 222 with the detected value(s) of the requested field(s) in document(s) 204.

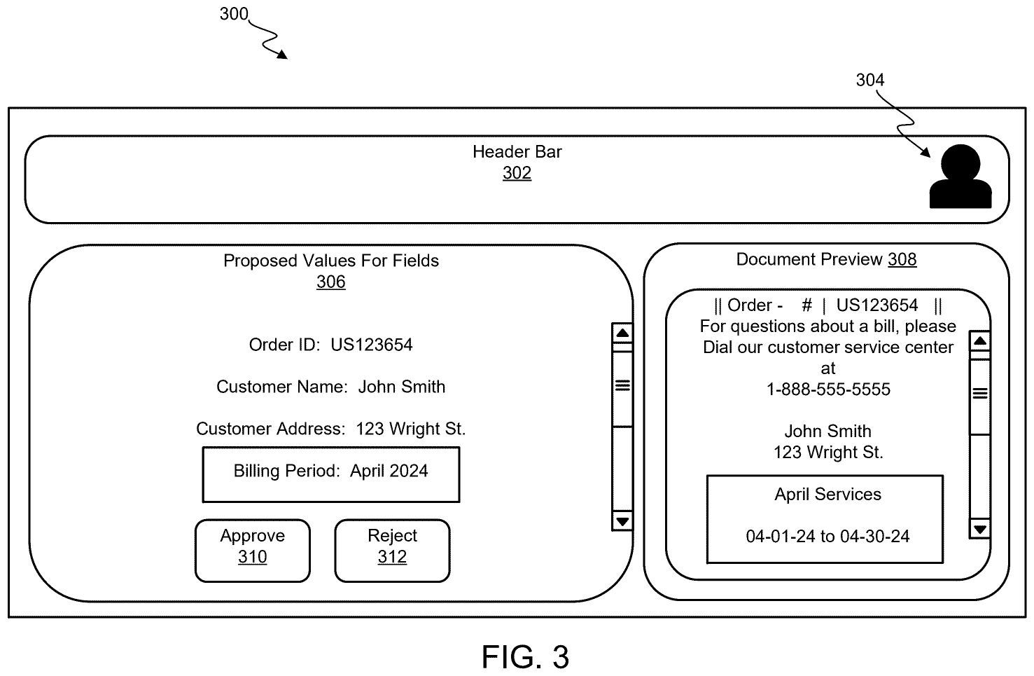

FIG. 3 illustrates a diagram of an example user interface 300 concurrently showing a selected field and value as well as where, in the document, the value for the selected field was detected. As shown, header bar 302 includes information such as which user 304 is authenticated into an application session. Interface 300 also includes proposed values for fields 306 and document preview 308. As shown, the value April 2024 for the field Billing Period is selected in proposed values for fields 306, and the document integration system has also located a portion of the document in document preview 308 as a source for the value April 2024. The user may review the information concurrently displayed and select approve 310 to approve the selection for storage in the database as proposed or select reject 312 to reject the selection and clear the value found for the field. Upon rejecting the selection, the interface also allows the user to type in a different value and/or locate the different value in document preview 308, such that additional feedback may be provided to the document integration system for providing better hints to the LLM for future documents being integrated.

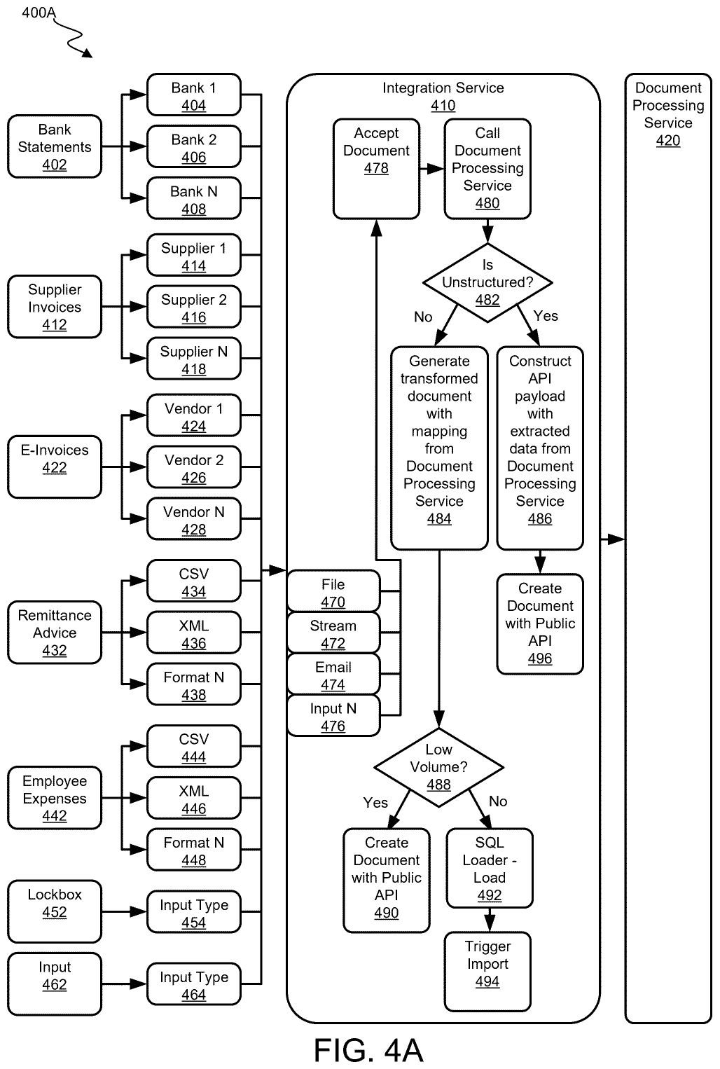

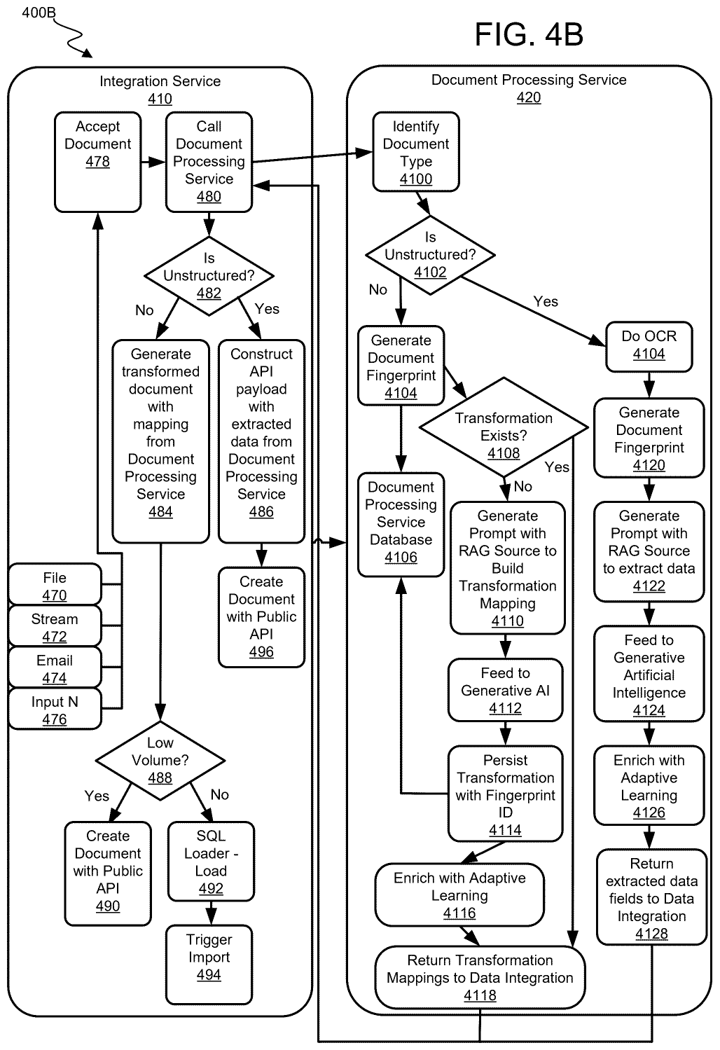

FIGS. 4A and 4B illustrate system diagrams showing example systems 400A and 400B that use generative AI enriched with metadata about historical document characteristics to transform documents of various formats, including images, to the fields and values they represent, for example, by detecting location(s) in which a large language model has detected value(s) of field(s) in document(s) and updating prompt template(s) to provide hints about the location(s).

Whether transformation is occurring for inbound or outbound documents, such transformation may be performed to find target value(s) for target field(s) in a document based on a target specification of a target data format that includes target fields. The document may be stored in a different format with different field(s) representing different parts of the document, or may be stored in a format where no field(s) are detected in the document. Regardless of how the document is initially stored, the target field(s) might match or not match the field(s) already known to be in the document. Additional document processing may be performed to find the target value(s) for the target field(s) based on an enriched prompt with data about the structure, definition, and/or possible value(s) of the field(s) to be detected in the document for transformation to the target data format. Once the target value(s) for the target field(s) are detected, the document may be stored in the target format as well as other formats, each potentially having different sets of field(s) and corresponding value(s) that are stored and used to construct one or more records or one or more files of the corresponding format based on the document. For some formats, the detected value(s) for the field(s) of that format may be inserted into a template specific to the format, such that the template, once filled in with actual value(s), forms a new record or file that represents data from the document but in a different format.

As shown in FIGS. 4A and 4B, various inputs 402, 412, 422, 432, 442, 452, and 462 are received in various formats 404-408, 414-418, 424-428, 434-438, 444-448, 454, and 464 customized to various parties and use cases. Integration service 410 receives inputs as a file 470, stream 472, email 474, or other input N 476. Integration service 410 accepts inputs 470-476 in step 478.

In one embodiment, transformations may be made between different formats of documents, and a machine learning model may determine a correspondence between underlying field(s) that often occurs when a large language model is prompted to separately detect value(s) for the field(s) in the document. For example, one format of a document may include a “Name” field, and another format of a document may include a “Full Name” field. After processing document(s), the machine learning model may observe that, with high probability, the value(s) chosen by the machine learning model for the “Name” field in one format is the same value(s) chosen by the machine learning model for the “Full Name” field in the other format. Based on these statistics-driven observations, the machine learning model may store a mapping between the “Name” field of one format and the “Full Name” field of another format.

In one embodiment, when integration service 410 calls a document processing service 420 in step 480. Then, integration service 410 determines whether the document is structured or unstructured. If structured, in step 484, the integration service 410 generates a transformed document with a mapping from document processing service 420. In step 488, a determination is made whether the volume is low or not. If the volume is low, in step 490, a document is created with a public API. If the volume is high, a SQL-Loader loads the documents in step 492 and triggers import in step 494. If the document is structured, in step 486, integration service 410 constructs an API payload with extracted data from the document processing service 420. Then, in step 496, integration service 410 creates a document with a public API.

FIG. 4B provides an example in-depth view of document processing service 420. Integration service 410 calls document processing service in step 480. In step 4100, document processing service 420 identifies a document type. In step 4102, document processing service 420 determines whether a document is structured or unstructured. If structured, a document fingerprint is generated in step 4104, and the fingerprint is stored to document processing service database 4106. In step 4108, a determination is made whether a transformation exists. If not, document processing service 420 generates a prompt with a Retrieval Augmented Generation (RAG) source to build a transformation mapping in step 4110. Then, in step 4112, document processing service 420 feeds the prompt to generative artificial intelligence (AI). In step 4114, document processing service 420 persists a transformation with a fingerprint ID in document processing service database 4106. Document processing service enriches input data with adaptive learning in step 4116 and returns transformation mappings to integration service 410 in step 4118. If a transformation already exists in step 4108, the existing transformation mapping is returned to integration service 410 in step 4118.

If a document is unstructured as determined in step 4102, document processing service 420 proceeds to do Official Character Recognition (OCR) on the document in step 4104. Document processing service generates a document fingerprint in step 4120, and generates a prompt with a RAG source to extract data in step 4122. The prompt is fed to generative artificial intelligence in step 4124 and inputs are enriched with adaptive learning in step 4126. Document processing service then returns extracted data fields to integration service 410 in step 4128.

In one embodiment, when the document integration system encounters a new document of a format that has already had field(s) mapped to another format, value(s) for the mapped field(s) may be automatically determined based on the mapping, according to the machine learning model, without prompting a large language model to re-process the document. In this manner, large batches of documents may be handled in bulk once the mappings are in place between formats and the documents have already been processed to detect field(s) in a format mapped to other formats.

In another embodiment, the machine learning model detects locations within documents of a certain format where the value(s) for field(s) are often or consistently detected. These locations may be used to extract the value(s) from the field(s) without prompting a large language model once the locations have been determined for the certain format of document. For example, these specific locations may be specific columns or rows of data in a structured document, and the specific columns or rows may be extracted from the structured document based on a stored mapping between document field(s) and location(s) within the document without prompting a large language model.

The field-to-location mapping may also be stored as metadata to promote more accurate processing of the document by a large language model if a large language model is consulted to locate value(s) for field(s) in the document based on the normal location(s) of value(s) for those field(s).

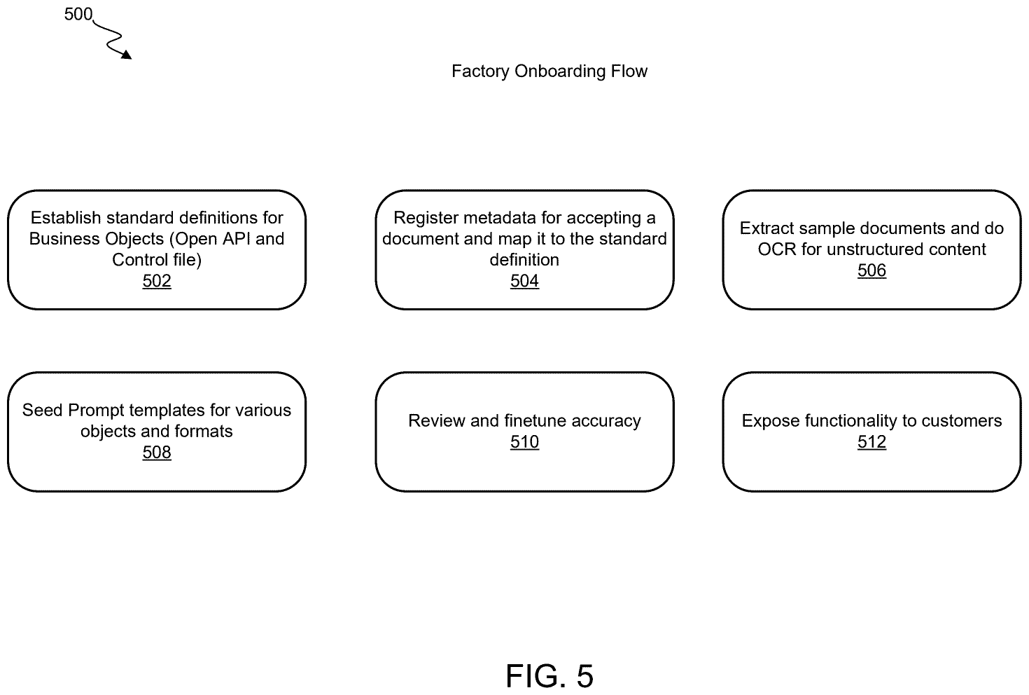

FIG. 5 illustrates a flow 500 for an example onboarding one or more tenants to a document integration system. As shown, in step 502, standard definitions are established for Business Objects (Open API and Control file). In step 504, metadata is registered for accepting a document and mapping it to the standard definition. In step 506, sample documents are extracted, and OCR is performed for unstructured content in the sample documents. In step 508, seed prompt templates are generated for various objects and formats. The templates are reviewed and finetuned for accuracy in step 510, and functionality is exposed to customers in step 512.

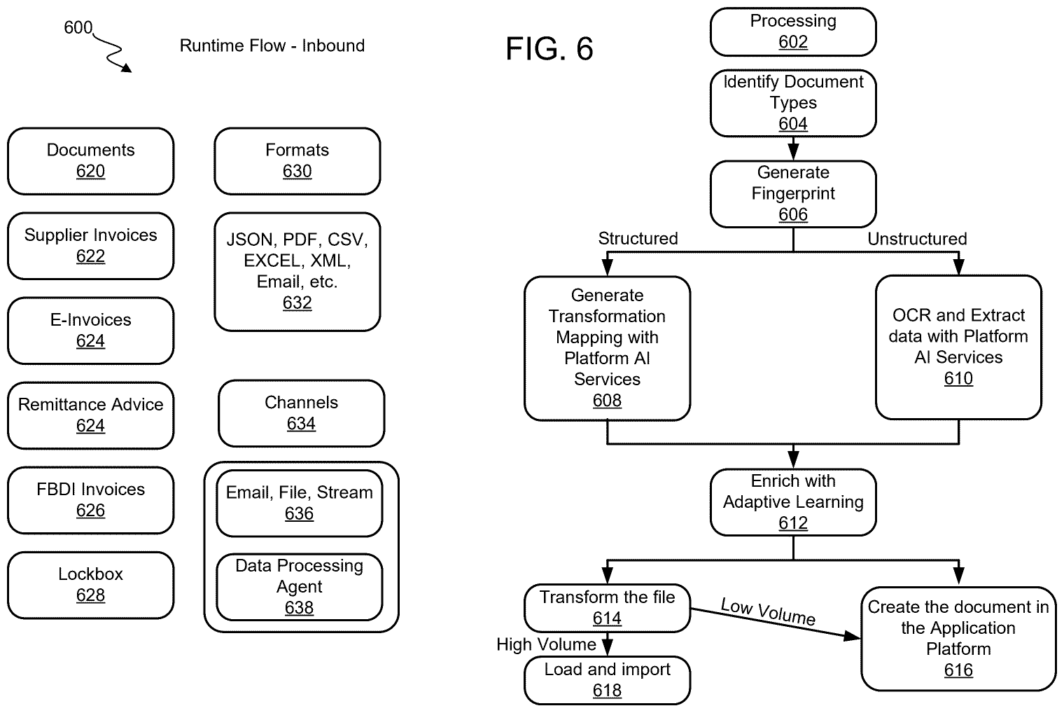

FIG. 6 illustrates a flow 600 for an example processing of documents to detect location(s) of value(s) of field(s) in the document(s) and updating prompt template(s) accordingly. As shown, documents 620 may include supplier invoices 622, e-invoices 624, remittance advice 624, FBDI invoices 626, and lockbox 628. Formats 630 may include JSON, PDF, CSV, EXCEL, XML, Email, etc., as shown in 632. Channels 634 may include email, file, stream inputs 636 as handled by a data processing agent 638. Processing 602 begins with identifying document types 604. Fingerprints are generated in block 606. For structured documents, a transformation mapping is generated with platform artificial intelligence services in block 608. For unstructured documents, OCR is used to convert the unstructured documents to text, and data is extracted with platform AI services. The data is enriched with adaptive learning in block 612, and the file is transformed in block 614. For low volume documents, the document is created in the application platform in block 616. For high volume documents, the documents are loaded and imported in block 618.

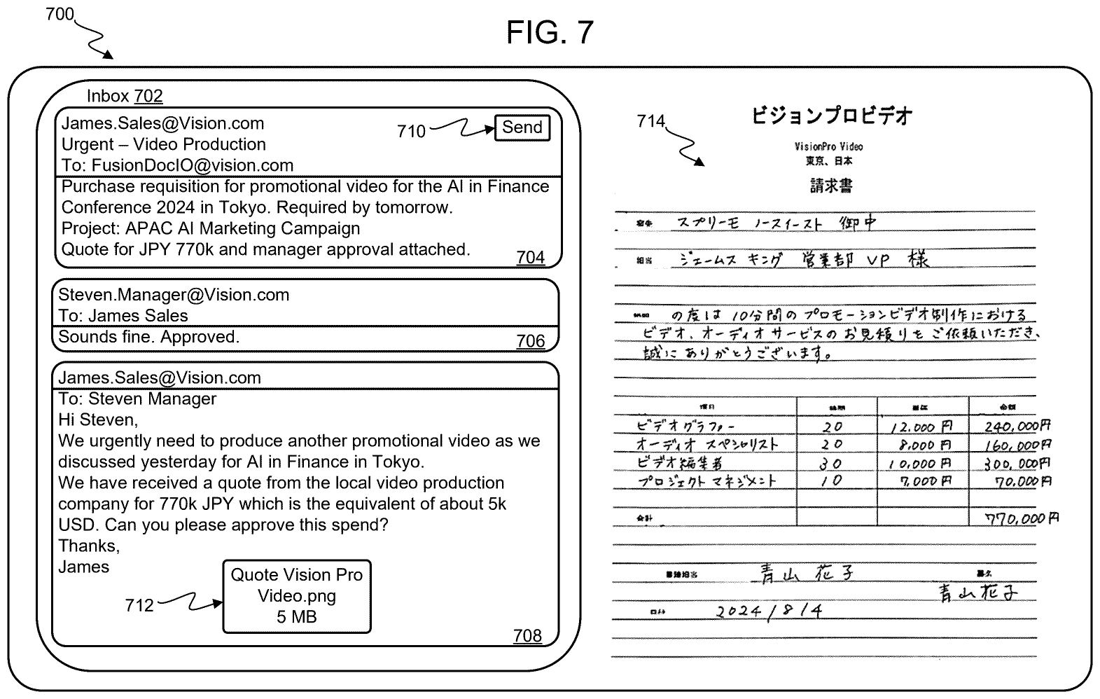

FIG. 7 illustrates an example document 700 in another language that may be processed according to the techniques described herein to detect location(s) of value(s) of field(s) in the document and for updating prompt template(s) accordingly. As shown, inbox 702 includes a thread of messages 704, 706, and 708, where messages are sent using a send option 710 to trigger import and processing of a document or image, such as a receipt, invoice, operations report, notice, or other data-containing document. An image 714 is included as an attachment 712 to message 708, which is ingested by the document processing system.

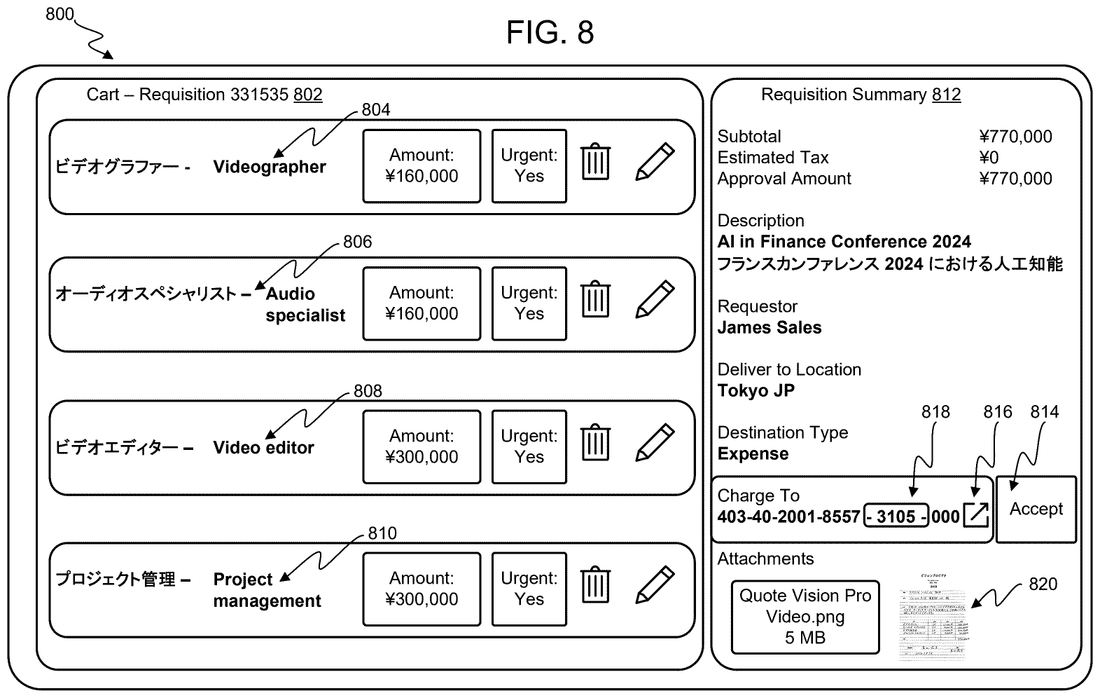

FIG. 8 illustrates an example interface 800 showing detected fields, detected translations of fields, detected values of the fields, and a summary of the document based on the detected values. As shown, a requisition item 802 includes several line item expenses 804, 806, 808, and 810, corresponding to different services and amounts as detected from image 714. The requisition is summarized in region 812 with various fields detected about the requisition, and a proposed value 818 is provided with an option 816 to find a different value in the document instead of the proposed value or otherwise override the proposed value and an option 814 to accept the proposed value. The attachment may include a preview 820 to show where data on interface 800 has been populated from.

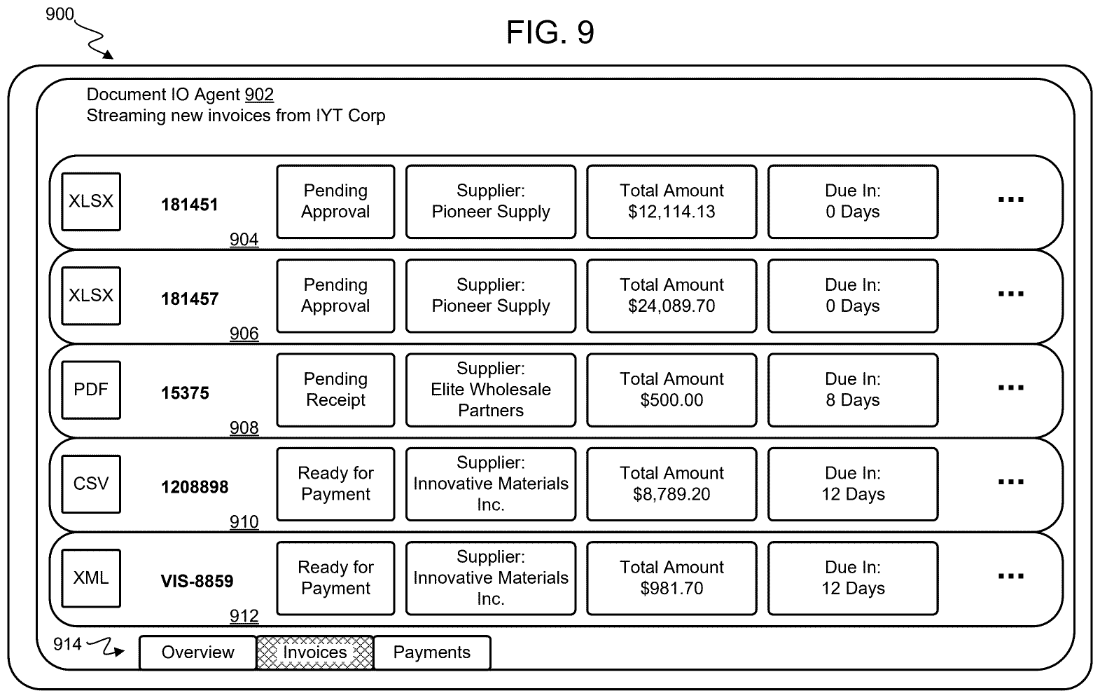

FIG. 9 illustrates an example interface 900 showing a pipeline of documents that have been processed or partially processed by the document integration system. As shown, items 904, 906, 908, 910, and 912 have been extracted by a document IO agent 902 from documents along with characteristics of the items such as amounts, deadlines, and statuses, detected from the documents. In the example, an invoices tab 914 is selected among tabs that are available for browsing on interface 900.

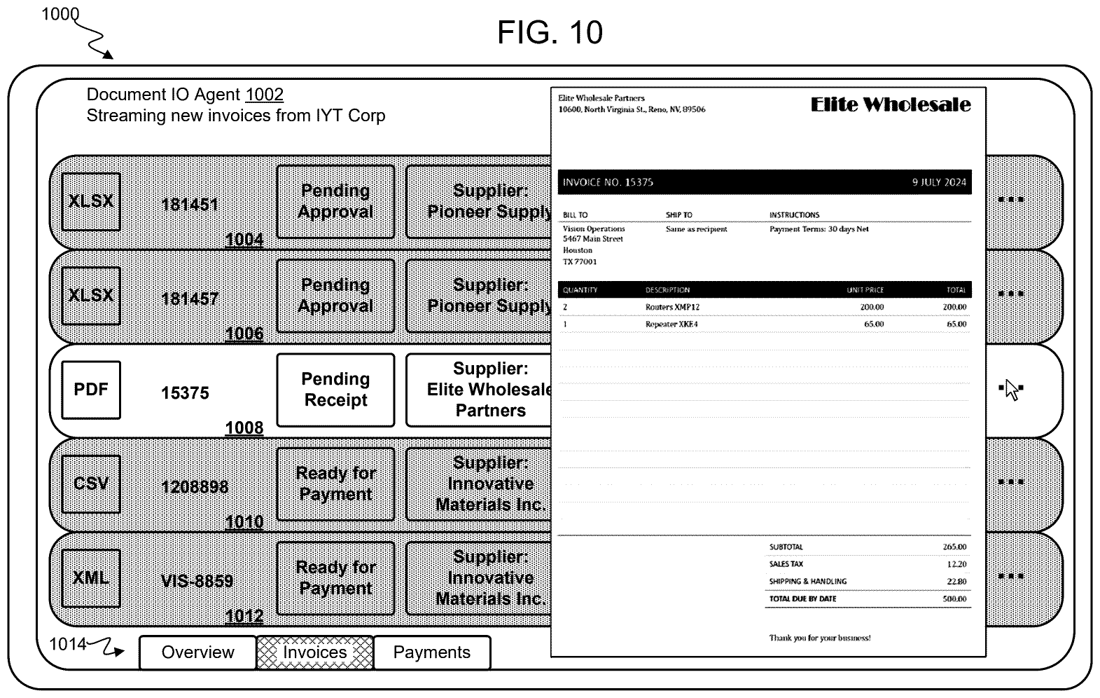

FIG. 10 illustrates an example interface 1000 showing a particular unstructured document that has been processed or partially processed by the document integration system. As shown, items 1004, 1006, 1008, 1010, and 1012 have been extracted by a document IO agent 1002 from documents along with characteristics of the items. A particular item identified as item 15375 has been selected, and a preview of the pdf item is shown in interface 1000.

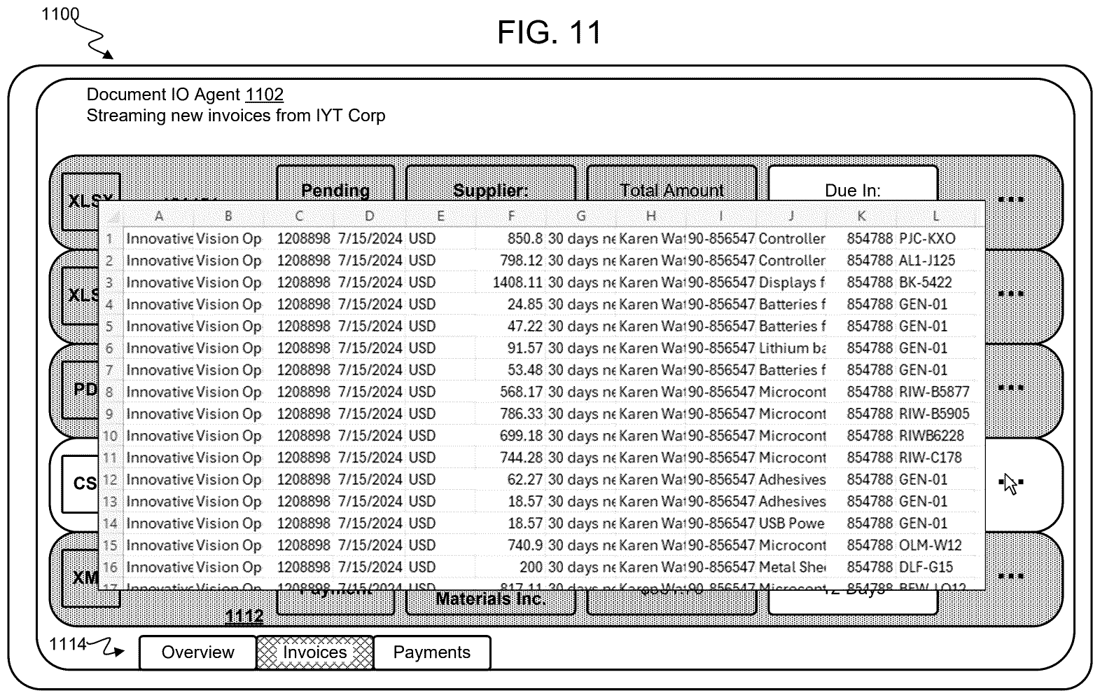

FIG. 11 illustrates an example interface 1100 showing a particular structured document that has been processed or partially processed by the document integration system. As shown, items have been extracted by a document IO agent 1102 from documents along with characteristics of the items. A particular item identified as a CSV structured data item has been selected, and a preview of the CSV structured item is shown in interface 1100.

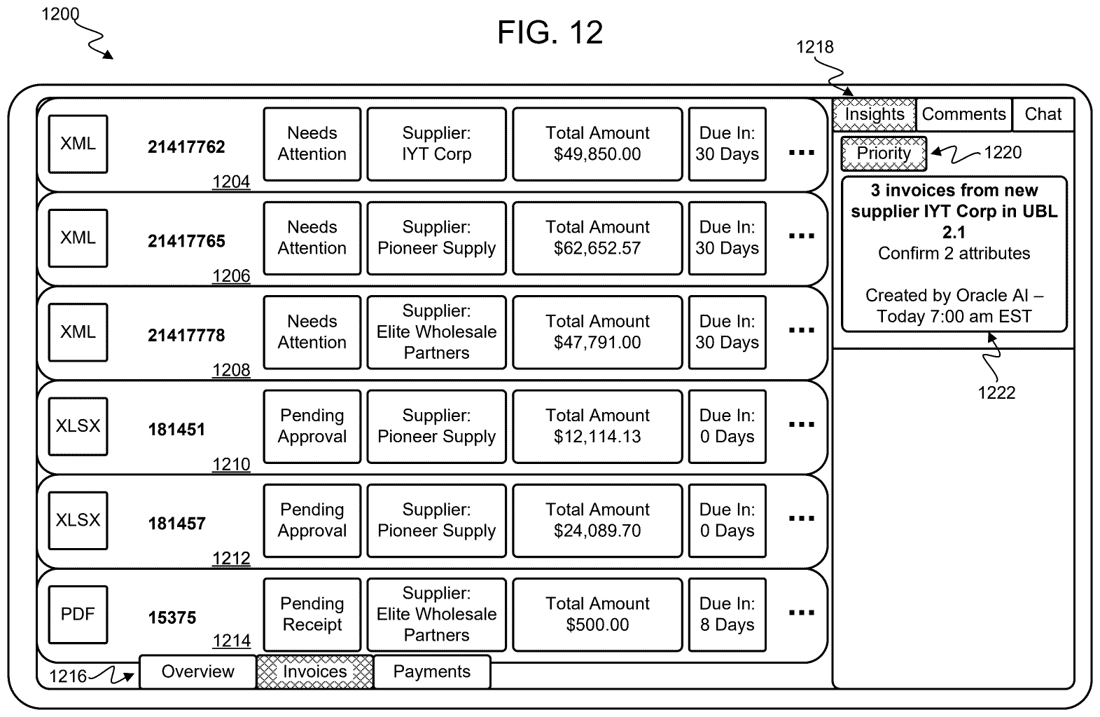

FIG. 12 illustrates an example interface 1200 showing a notification about incoming documents for which user review is requested. As shown, items 1204, 1206, 1208, 1210, 1212, and 1214 have been extracted by a document IO agent 1202 from documents along with characteristics of the items. An insights tab 1218 has been selected, and a notification 1222 is shown with a priority tag, marking, or other graphical indication 1220. The notification indicates that 3 invoices from a new supplier have been ingested to items 1204-1214, along with an option to confirm attributes of those items.

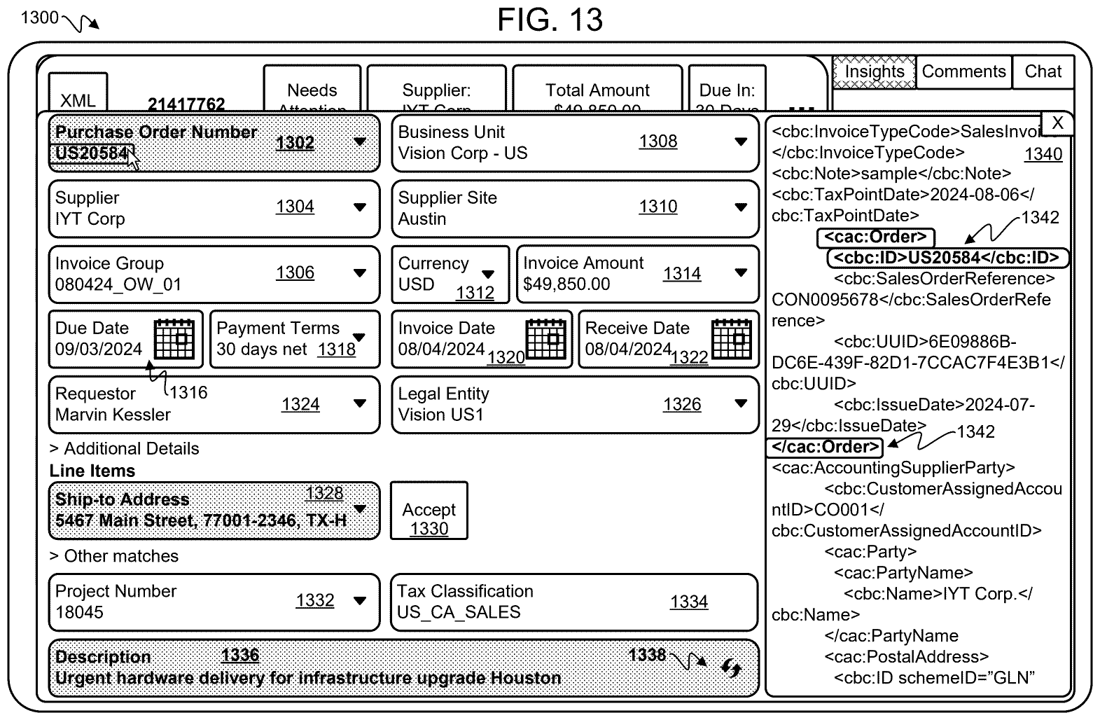

FIG. 13 illustrates an example user interface 1300 concurrently showing a selected field and value as well as where, in the document, the value for the selected field was detected. As shown, information for a particular item is shown in fields 1302-1336, along with options to see what locations 1342, in the document 1340, values of the fields, such as selected field 1302, are found. In the example shown, locations 1342 are indicated by a start of a container, tag, or marking for the location, an end of a container, tag, or marking for the location, and a value “US20584” contained between the start end ends of the container in the document 1340, a relevant portion of which is shown based on the selection.

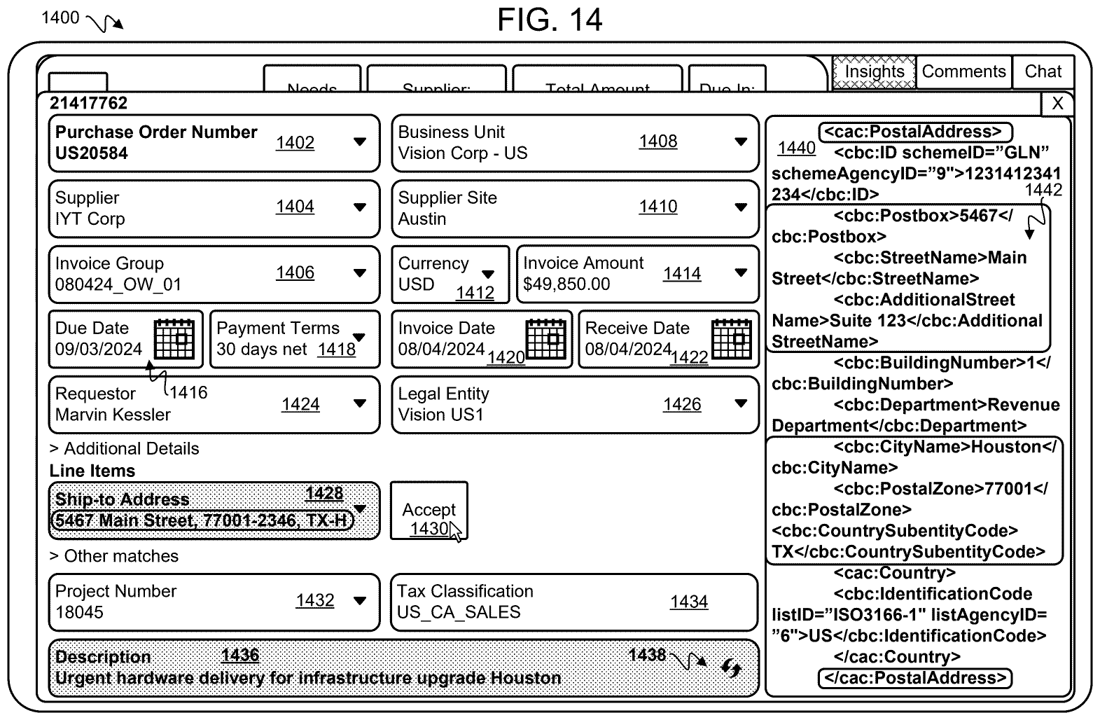

FIG. 14 illustrates an example user interface 1400 concurrently showing another selected field and value as well as where, in the document, the value for the other selected field was detected. As shown, information for a particular item is shown in fields 1402-1436, along with options to see what locations 1442, in the document 1440, values of the fields, such as selected field 1428, are found. In the example shown, locations 1442 are indicated by a start of a container, tag, or marking and sub-containers for the location, an end of a container, tag, or marking and sub-containers for the location, and values “5467,” “Main Street,” “77001,” “Houston,” and “TX” contained between the start end ends of the container and sub-containers in the document 1440, a relevant portion of which is shown based on the selection. In the example shown, the user interface 1400 shows a mapping between the fields and the values in the document. In a database or data store used by the user interface 1400, a direct mapping may be stored between the field and the value, alternatively or in addition to the mapping to the location in the document. The document may be represented using a variety of different markup languages to represent data or images in the document, and such representations may be the same or different from the one shown in FIG. 14.

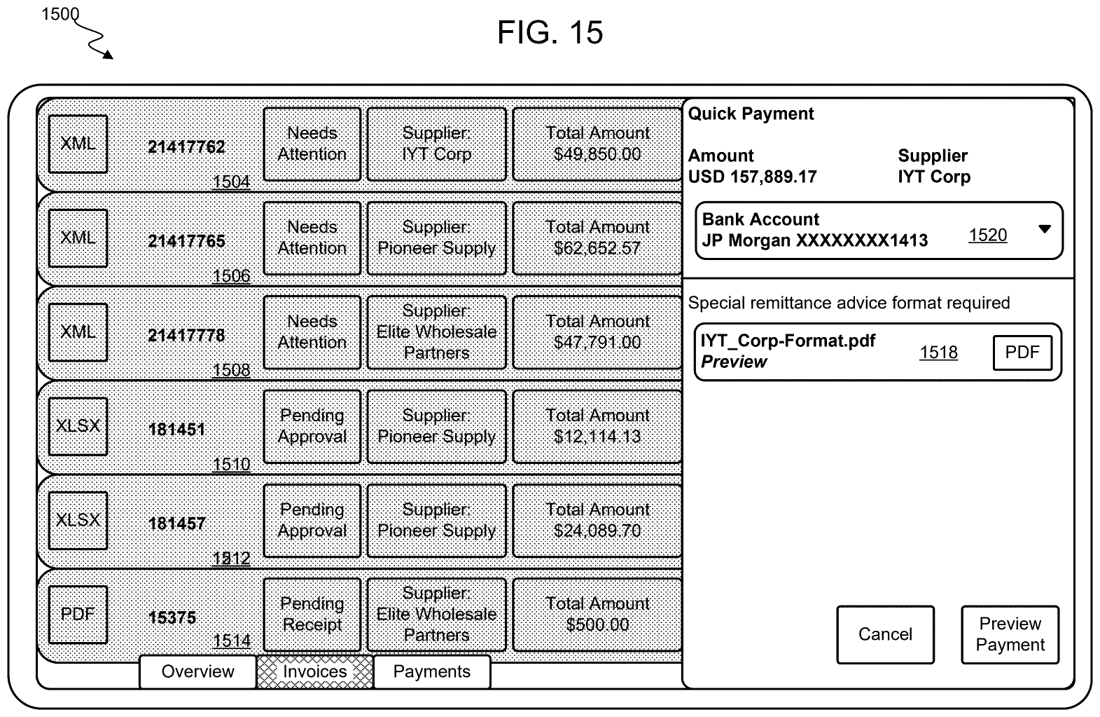

FIG. 15 illustrates an example user interface 1500 showing a request for a document in a specific format. As shown, items 1504, 1506, 1508, 1510, 1512, and 1514 have been extracted by a document IO agent 1502 from documents along with characteristics of the items. An option 1518 to generate a payment document is shown, where the generated document can be previewed and is conformant to a particular format for a particular vendor, and the document is stored as a pdf document type. The option may include metadata from an account or other selected information 1520.

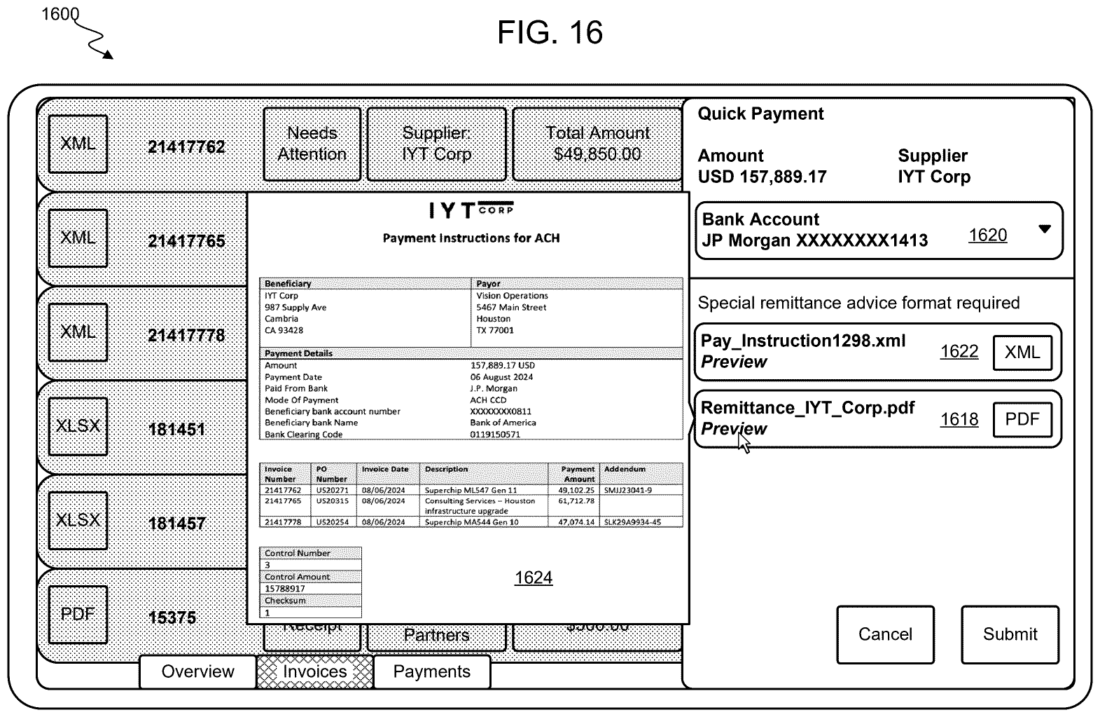

FIG. 16 illustrates a user interface 1600 showing a document automatically generated in the specific format available for output. As shown, an option 1618 to generate a document is shown, where the generated document can be previewed and is conformant to a particular format for a particular vendor. The shown document 1624 is stored as a pdf document type and may be previewed in an overlay on the interface 1600. Previewed document 1624 may include selected data 1620 from interface, such as an account from which the payment is being made. Other documents 1622 may also be available for generation in other formats.

### Matching Incoming Documents to Document Categories

Documents from any source may be added to a Document IO pipeline where a document integration system analyzes the document to determine steps for integrating the document into a database. In one example, the Document IO pipeline matches incoming documents to document categories based at least in part on contents of the incoming documents. If the document represents text but is in image format, the document may be first transformed into text format using an image-to-text conversion or optical character recognition (OCR) tool such as Tesseract OCR, ABBYY FineReader, EasyOCR, PaddleOCR, Google Cloud Vision OCR, Microsoft Asure OCR, and/or Amazon Textract.

The document integration system may support document processing requests from multiple tenants and support document integration with tenant-specific databases using tenant-specific large language model sessions to help in determining the value(s) of field(s) present in the documents.

The documents to be ingested may be captured on a smartphone or other device with a camera, and a picture of the document may be sent via email, Short Message Service (SMS) text message, input via a user interface of an application (such as an application on a mobile device), or input as an application-layer message to a document ingestion email for the user's organization. A document reporting service may receive the message from the user and pull information about the user from a user profile stored in association with an endpoint of the message (e.g., a phone number, email address, or username from which the message was received). The information from the user profile may be used to prompt the LLM for information about the document based at least in part on information, added to the prompt, about the user.

The document integration system may use APIs or library bindings to incorporate the OCR tool into the document integration system. For example, Tesseract OCR may be integrated using the pytesseract library; ABBYY FineReader may be integrated using a RESTful API via HTTP requests; EasyOCR itself is a library that can be integrated; PaddleOCR may be integrated using the paddleocr library; Google Cloud Vision OCR may be integrated using the google-cloud-vision library; Amazon Textract may be integrated using the boto3 software development kit; and Microsoft Azure OCR may be integrated using the azure-cognitiveservices-vision-computervision library. The document integration system may integrate with any OCR tool using APIs, libraries, or integration services such as Oracle Integration Cloud that manage connections between applications. Different types of OCR tools may handle different types of documents with different levels of accuracy, and different tools may be used for different document types in the Document IO pipeline.

In various embodiments, the OCR tool may convert the text to English text or may leave the text in a native language, which may be English, Chinese, Spanish, Arabic, Devanagari, or any other language. If the text is left in a native language, a prompt to the LLM may include the text in its native language, and the LLM may be configured to ingest text of that language or of mixed languages in order to provide responses to prompts. Allowing the LLM to process the native language text, which is output from the OCR tool, provides the advantage of allowing the LLM to infer meaning from surrounding context when multiple different valid translations are available between languages. The LLM may understand how different texts of a native language are related to each other, and such understanding may be lost or partially lost once the texts have already been translated using OCR techniques and/or other language translation tools. In various other embodiments and scenarios, the OCR techniques and/or other language translation tools may provide adequate translation of text that is consumed by the LLM with little or no information loss.

Once the document has been converted to text, the document integration system may determine a category for the document based on the text. In one embodiment, the category is determined by comparing vector embedding of the text content of the document with sample vector embeddings of documents in different categories, and a corresponding category of the sample vector embedding most closely matching the text may be chosen as the category for the text. In this document fingerprinting approach, the similarity between the vector embeddings may be determined, for example, using cosine similarity or any other vector distance metric, such as Cosine Distance, Euclidean Distance, Pearson Correlation Coefficient, Manhattan Distance, Minkowski Distance, Hamming Distance, Chebyshev Distance, Jaccard Distance, Haversine Distance, and/or Sorensen-Dice Distance.

The distance or similarity analysis may be performed on the whole vector embedding or by breaking up vectors into components to determine correlation of corresponding components across the vectors. For example, a first vector and a second vector may each include a component that indicates an area code of a phone number, and the area codes may be correlated across vectors even though the rest of the phone number is not correlated. The column correlation may be determined by comparing the correlation determined according to as the similarity measure to a correlation threshold as a correlation criterion. The columns may be counted as correlated if the correlation measure exceeds the correlation threshold. In an alternative embodiment, the columns may be compared to determine correlation clusters, where columns are determined to be part of a cluster if the correlation between all combinations of columns in the cluster is above a certain threshold.

A Pearson Correlation Coefficient between two vectors is calculated as a ratio between the covariance between the vectors and the product of the standard deviations between the two vectors. A correlation coefficient of 1 represents identical vectors, a correlation coefficient of −1 represents opposite vectors, and a correlation coefficient of 0 represents vectors that are not correlated.

A Cosine Distance or cosine similarity between two vectors is determined by calculating a cosine of the angle between the two vectors. A result of 1 represents a cosine similarity between two identical, a result of −1 represents a cosine similarity between two opposite vectors, and a result of 0 represents a cosine similarity between two unrelated or orthogonal vectors.

A Euclidean Distance is determined by calculating a square root of a sum of the squares of the distances between components of the two vectors. The higher the Euclidean distance, the lower the similarity between the components of the vectors used in the calculation.

A Manhattan Distance is calculated as a sum of the absolute differences between components of the vectors. The higher the Manhattan Distance, the lower the similarity between the components of the vectors used in the calculation.

A Minkowski Distance is calculated as the p-th root of the sum of the absolute differences between components of the vectors raised to a power, p, for each component pair. The Minkowski Distance equals the Manhattan Distance when p=1 and the Euclidean Distance when p=2. The higher the Minkowski Distance, the lower the similarity between the components of the vectors used in the calculation.

A Hamming Distance between two vectors is determined based on how many positions at which corresponding components of the vectors are different or sufficiently different. For each component pair in the vectors that are different, a counter is incremented. The Hamming Distance is the total counter for the vectors across all component pairs.

A Chebyshev Distance between two vectors is calculated as the greatest of the absolute differences among the vectors' corresponding components. The largest absolute difference among all the pairs of components is the Chebyshev Distance. The larger the Chebyshev Distance, the lower the similarity between the vectors.

A Jaccard Distance between two vectors is calculated as a ratio between the size of the intersection between the vectors (based on elements in common between the vectors) to the size of the union between the vectors (based on elements in either or both of the vectors). Jaccard Similarity is defined by the ratio, and Jaccard Distance is defined as one minus the Jaccard Similarity.

The Sørensen-Dice Similarity is calculated as two times the number of elements in common among the vectors divided by the sum of the number of elements in each vector. The Sørensen-Dice Distance is one minus the Sørensen-Dice Similarity.

Various techniques may be used for determining similarity of an incoming document and categories of documents. In one embodiment, for example, if the similarity of the incoming document is not above a threshold level of similarity, the category may be chosen by prompting a large language model for the category. For example, the large language model may be prompted to select from a list of categories the category most appropriate for the text of the incoming document. As a result, the large language model may return the category, which is then used for further processing of the text.

In some embodiments, and a multi-agent architecture is used where a classification agent analyzes a document, potentially with specialized steps and/or access to tools, which may be accessible through APIs or other interfaces and may have separate authentication parameters or keys used by the classification agent. The classification agent may interact with an LLM to determine a classification for a document, and the document may be further processed by other integration agent(s) for detecting content within the document to store in data structures accessible to the document integration system.

Below is an example prompt template for the Classifying the category:

### Instructions:
Examine the text of the expense receipt carefully and determine the most appropriate
category from the following options:
1. **Accommodation** - Includes expenses made at hotel or resort for accommodation.
Usually Includes itemized list of expenses (room charges, room taxes, room services), and
the total balance. Usually found in hotels and resorts, detailing charges accrued during the
stay.
2. **Miscellaneous** - Covers expenses such as gas, parking, groceries, and supermarket
purchases.
3. **Car Rental** - Includes expenses related to car rentals, common car rental companies
are Avis, Enterprise, Hertz, Alamo, Sixt, Thrifty, Dollar, Budget.
4. **Meals** - Includes expenses made at restaurants for meals.
5. **Airfare** - Includes expenses for airfare travel tickets.
6. **Taxi and Ridesharing** - Includes expenses for Taxi or Ridesharing services like Uber
and Lyft.
### Question:
Based on the descriptions above, which category does the following expense receipt belong
to? Please pick only one category name from ‘Accommodation’, ‘Miscellaneous’, ‘Car Rental’,
‘Meals’, ‘Airfare’ or ‘Taxi and Ridesharing’ in the output with no further explanation or
additional notes.
### Expense Receipt Text:
“{target_receipt_text}”
### Output:

Regardless of the technique for selecting a document category, the document integration system may match an incoming document to a document category for further processing and then perform further processing steps for the document that depend on the selected category.

In one embodiment, when a particular type or particular category of document is first received, a fingerprint or vector embedding is generated for that particular document. The fingerprint and/or source of the particular document is saved in a collection of fingerprints for a collection of document categories. When a similar document is received later, the similar document will be matched to the fingerprint and/or source of the particular document, and a prompt template and/or metadata specific to the particular category of the particular document may be used for processing the similar document. For example, the metadata may indicate location(s) of value(s) for different field(s) in documents of the category, marker(s) in the documents to look for and position(s) relative to the marker(s), section(s) of the documents, or other pattern(s) where value(s) for field(s) have been found. The metadata may be applied to multiple different documents in the category to improve learning capabilities with the LLM as applied to new documents in the category even if the new documents have never before been seen but still use a document structure or content that is similar to prior documents.

In one embodiment, high-level categories are maintained for documents of certain types regardless of entity, vendor, or other characteristics, and lower-level categories are maintained for documents from certain entities or vendors, having specific file formats, or other document characteristics.

### Selecting and Configuring a Prompt Template for Prompting an LLM

In one embodiment, a selected category of an incoming document is used to select a prompt template for processing text of the incoming document. Different prompt templates may be configured to pull information out of different types of documents, and the different prompt templates may also include template-specific metadata for where in the documents corresponding portions have frequently been found based on prior uses of the prompt template to extract the corresponding portions. For example, a prompt template may include metadata that indicates location(s) of value(s) for different field(s) in a document, marker(s) in the document to look for and position(s) relative to the marker(s), section(s) of the document, or other pattern(s) where value(s) for field(s) have been found. The different prompt templates may refer to same, different, or partially overlapping fields, and the different prompt templates may share metadata for the same fields or may use separate metadata even though the same field is being located in the separate categories of documents, for example, due to the variation of how that field is presented in the different categories of documents. As the prompt template is used to locate value(s) for field(s) in documents sharing the same category, the metadata may guide a large language model to more precisely extract relevant value(s) for the field(s).

In various embodiments, the prompt templates may include field names and definitions such that the content of the field is defined to the LLM. The prompt templates may also include example output formats so that the LLM provides results in a consistent format as specified in the prompt templates. The output formats may be consumable by the document integration system for moving the resulting data into a database. For example, the output formats may be structured in JSON in conformance with a schema or structure that is expected by the document integration system.

### Selecting an LLM to Process Prompt Templates

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-4 or gpt-3.5-turbo. Other example providers include, but are not limited to, Cohere (e.g., Cohere Command), Azure AI, Google PaLM 2, Meta Llama3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data to which the prompt relates. The data schema may include dimension names (e.g., Scenario, Market, Year, Product, and Measures), member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

The prompts may also specify a format for providing the reply, through examples and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The consumable JSON object may be separated from a remainder of the response for consumption by the application to create an executable structure to trigger application functionality.

### Prompting the LLM to Find Value(S) of Field(S) in the Document

Once a prompt template has been selected, the document integration system may prompt a large language model (LLM) to find value(s) of field(s) in the document using a prompt based on the prompt template. To generate the prompt, the prompt template may be filled in with variables or metrics to indicate where, in the document, value(s) for the field(s) are most likely to be found based on where value(s) for the field(s) have most often been found in the past. The prompt also includes the text of the incoming document that is being provided for analysis. The prompt template may also include other instructions specific to the category of document, such as guidance on the subject matter contained in the category of document or guidance of common formats, headers, footers, or sections of the category of document. The LLM may consume the prompt and generate a structured response that indicates what value(s) were detected for what field(s) in the text. The response may also indicate where, in the text, the value(s) were detected.

In various examples, the prompt may guide the LLM on characteristics of the text to look for in relation to values for fields such as the invoice number, the invoice amount, the vendor name, the supplier name, a description of the good(s) or service(s) purchased, the line item(s), characteristic(s) of the line item(s), or any other fields the prompt template is configured to pull from documents in the category.

In one embodiment, the message transmitting the document may include location information about where the message originated. The location information may be included in the prompt to the LLM as metadata to guide the LLM to select an establishment (e.g., restaurant or hotel) that is near a location from where the document was sent rather than an establishment in a different city. If the address of the establishment is not in the document, the LLM may infer the address based on the name of the establishment from the document and the location from which the document was sent, as the closest establishment to that location having that name or a similar name.

Other information from the user's profile may also include details about the location or purpose of the visit. For example, the user may have received approval for travel to a particular city, purchased flights to a particular city, or started a particular business trip with a particular purpose for which expenses are being submitted. This location and purpose information may be included in the prompt to the LLM, with the document text, to provide a better detection of field values based on the text.

The date or time of the document submission may also be used to guide extraction of date and time information by the LLM. The prompt may include a date and/or time on which the document was submitted and an average date and/or time after events on which documents are historically submitted for the category of documents. For example, the document may have been submitted at 8:30 p.m., and metadata stored in association with a document prompt template indicates that, on average (or median or mode times), documents are submitted 75 minutes after an event. The LLM may use this information, included in the prompt, to better guess the date and/or time the document was submitted when the text is not clear or may be inaccurate (as being handwritten and improperly recognized with the wrong characters).

In various embodiments, user-specific patterns of correctly detected text or incorrectly detected text may be provided from the metadata for inclusion in the prompt. For example, if a user's handwriting is often misunderstood by the LLM such that mistaken values are frequently returned by the LLM, such information may be included in the prompt template on a user-specific basis as metadata for the LLM to determine how much weight to give to portions of the document that are more likely to have been handwritten. A user whose handwriting has caused few inaccuracies may be given high weight to officially recognized characters, and a user whose handwriting has caused many inaccuracies may be given low weight to officially recognized characters and proportionally more weight to heuristics, logic, or mathematical calculations that are normally consistent for the type of document.

For certain types of documents, the prompt template may include additional information that might not be available for other types of documents. For example, the prompt template may include information about a user submitting the document, about a user's physical location when the document was submitted, about a user's travel itinerary at or around the time the document was submitted, and other details that provide hints to the LLM about what the document may concern. For example, this additional information may help the LLM pinpoint a city or neighborhood from which the document was submitted, narrowing down a set of suppliers, vendors, consumers, or other entities that may be associated with the document.

In one embodiment, the LLM may identify some value(s) for some field(s) that are not provided word-for-word in the document. The LLM may use inference, for example, to fill in field(s) relating to a document description or summary, or to determine a likely deadline or due date. In these examples, the LLM may be prompted to determine the value from aggregate content of the document rather than explicitly finding the value. Different field(s) identified in the prompt template may be marked as allowing summarization or as requiring that the value is explicitly located word-for-word in the document, depending on the type of document and the use case.

### Integrating a Result FOM the LLM into the Database

The response from the LLM may include structured data that is consumed by the document integration system. For example, the prompt may have requested the data in JSON format, XML format, or any other format, and the prompt may have requested that the response conforms to a certain schema or references certain fields, optionally whether or not values were found for those fields. The structured object may be consumed by the document integration system, which triggers database operations such as creating a record corresponding to the category (e.g., an expense, a receipt of funds, etc.), writing the value(s) into the corresponding field(s) of the record, saving the document itself as metadata to the record, and/or saving the text of the document as metadata to the record.

In one embodiment, different documents may be fed into the document integration system, triggering prompt to the LLM to identify value(s) for field(s) of each document, and proposed data structure mappings may be generated based on the LLM results for each of the different documents. The proposed data structure mappings may be imported in bulk, in batches, or streaming in to the system, triggering operations to store the text determined from the documents in various data structures as specified by the proposed data structure mappings.

In one embodiment, proposed value(s) for field(s) to be imported or that were imported from a document may be reviewed. The document integration system may show the proposed value(s) and where, in the document, the value(s) for the field(s) were found. A reviewer interface may be shown for accepting or rejecting proposed values, and selecting different values for review may cause a changed navigation of the document in a document viewer such that location(s) of the document showing the selected value(s) are placed in focus on the user interface and other parts of the document may be moved off of the screen as a result. The option to accept or reject proposals may trigger feedback to a metadata management system that keeps track of where, in past documents, values for field(s) have been found so that a specialized prompt template may use metadata about the past location of values for field(s) as a hint to the LLM for finding future values of the field(s).

In one embodiment, the reviewer interface highlights those fields that have the lowest confidence of an overall match. The confidence level of the match may be determined by the LLM as metadata in a structured result. For example, then the LLM returns a result that indicates the value found for a field and the identity of the field, the result may also indicate a confidence of the match between the value and the field. The confidence may be specified in a range of 0 to 10 or 0 to 1, for example, and the LLM may provide the confidence and even a rationale for high or low confidence for each individual mapping of value to field. Such confidence scores may cause certain lower confidence values (e.g. below a threshold confidence) to be highlighted in the reviewer interface and/or certain higher confidence values (e.g. above a threshold confidence) to be automatically accepted and/or not highlighted for review. The reviewer interface may also display a rationale for the high or low confidence score so the user can understand why the value was selected by the LLM and the graded risk from the LLM that the value is not the correct value.

Additionally or alternatively, with respect to certain types of documents, the field values determined by the LLM may be matched against existing values in a database. For example, the documents may be matched against a set of separately logged data spanning an overlapping time period for an account that is accessible to the document integration system (e.g., a supply intake log, a corporate card account, or a tax reporting account). If the LLM determines value(s) of field(s) of a document that do not exactly match a logged data item, the closest matching logged data item may be matched with the field value(s) detected in the document with a degree of confidence determined based on how closely the field value(s) of the document matches a logged data item as well as how distantly the field value(s) of the document matches any other logged data item. For example, if the logged data item is the only logged data item that is near the field value(s) from the document (e.g., based on a vector distance of a vector embedding of contents of each candidate logged data item and a vector embedding of the field value(s) of the document), the document integration system may determine with high confidence that the two values match even though they do not list exactly the same value.

If the confidence is above a threshold amount, the document integration system may treat the logged data item as a likely correctly matched data item and provide feedback to a metadata management system on the actual value(s) that were used as the logged value(s) determined from the document. The document integration system may also determine where, in the document, was the closest text to the logged value(s), and provide metadata about location(s) of the logged value(s) within the document even though the LLM identified different value(s) potentially from different location(s) in the document. The metadata about the location(s) of the logged value(s) may be used to provide hints from the metadata management system, built into prompt template(s) specialized for certain type(s) of documents, entities, or document-entity pairings (e.g., optionally specific to certain entities with which a document handling entity is doing high volumes business and/or that has specific document structures in documents coming in from the entity), such that the prompt template with the hints may be used to find value(s) with higher accuracy for future documents. For example, the value(s) may be found in sections near the beginning of documents from some entities and near the end of documents from other entities, or near the beginning of documents for some types of documents and near the end of documents for some other types of documents.

Once a document has been processed and value(s) assigned, for example, in a database, and/or images saved in association with new, updated, or existing records that store the matched data item(s), the document integration system may respond to the user via a text message, email, or other message in real time (synchronously with the submitted document) or asynchronously within quality of service guarantees (e.g., every minute, 15 minutes, hour, or day) indicating the field value(s) that were detected and categories of the field value(s) along with an option for the user to confirm or reject the field value(s) and/or matched data item(s) via a reply message or other selection.

The user may additionally or alternatively receive a message when the document is matched to a separately logged data item, indicating which logged data item was matched and/or what field value(s) were detected for the logged data item from the document, along with an option to confirm or reject the match between the logged data item and the document. In one embodiment, key values in the document may be used to match the incoming document to a logged item. For example, the document may include a record identifier, an entity name, a description, and/or other textual data such as numerical or alphanumerical data, and the logged item that is matched may include logged data that is determined to be most similar (e.g., by matching a vector embedding of the logged item to a vector embedding of detected content from the document most closely in vector distance) to the document content. If there is a discrepancy between a matched logged item and the document content, a message about a discrepancy may be sent to the user requesting confirmation or rejection of the match along with an explanation for why the match was made (e.g. partially matching field values) even if some of the field values detected from the document did not match with the logged item.

In various embodiments, some characteristics detected for the document may be used to inform other characteristics of the document. For example, location may be used to determine an office branch, sales region, factory source, currency, merchant, tax rates, and, in some cases, amounts. For example, a particular location may be associated with documentation that regularly or frequently occurs with a certain entity and is regularly or frequently defined by certain characteristics, and additional details of the document may be clarified in some cases based on the location even if the details are not otherwise clear from the document itself.

### Updating Metadata for the Document Category to Improve the Prompt Template(s)

The response from the LLM indicates what value(s) were found for which field(s) in the text of the incoming document. In one embodiment, this information may be used to update metadata for the corresponding prompt template. For example, the document integration system may determine document metadata that indicates a value for a field was found near the beginning/ending of a document or section of the document or any other location in the document, at a position relative to certain marker(s) or section(s) that were identified in the document, such as before or after or between the marker(s) or section(s), or within a certain number of characters of the marker(s) or section(s), or based on any other pattern(s) where the value was found. The document metadata may be merged with metadata for a plurality of documents to which prompt template(s) have been applied for the category of documents in order to determine new aggregated metadata to use for the prompt template(s). For example, if the value for the field was found closer to an “PAID TODAY” marker than values for the field had been found in prior documents, the metadata for the category of documents may be adjusted such that the prompt template indicates that values for the field may be within 19 characters of the “PAID TODAY” marker rather than within 20 characters of the “PAID TODAY” marker. Such metadata (from adaptive learning and/or human annotation, such as an input identification of the location, section, or marker relative to where the value is found) may be used directly for enhancing the data extraction result with or without being used for updating/improving the prompt template. In addition to enhancing the individual result, the metadata may also be inserted into multiple prompt template(s) or prompts when handling documents that satisfy applicable characteristics or document types for which the metadata was collected.

The absolute or relative positions of the values located may be directly in the LLM response and/or may be determined or verified by the document integration system based on the LLM response. For example, the document integration system may see that “$123” was found for the “amount paid” field and may analyze the text of the document to determine where, in the document, the value of $123 occurred. The document integration system may also determine whether any common section headers, footers, delimiters, or patterns or other markers are present in the document and store the detected position of the $123 value relative to the detected markers as well as in absolute terms for the document or relative to the start or end of the document. Such absolute and/or relative location(s) may be supplied to a metadata management system for managing metadata for the various categories. The metadata management system may then store aggregate location metrics that are common for finding values of different field(s) in documents in the category. The metadata management system may similarly manage metadata for a plurality of categories, each of which may have one or more prompt templates used for integrating documents in the category.

In one embodiment, a user may provide feedback to the LLM on a quality of value suggestions for fields detected in the document. The document integration system may show a user interface that displays the document along with field(s) and corresponding value(s) detected in the document. The user interface may display an option to select field(s) that were correctly matched to provide positive feedback to the model, indicating that similar locations, markers, and document structure should be relied on more in future iterations to find values for the field in other documents of the category. The user interface may also display an option to select field(s) that were incorrectly matched to provide negative feedback to the model, indicating that similar locations, markers, and document structure should be relied on less in future iterations to find values for the field in other documents of the category. As further feedback for field(s) incorrectly matched, the user interface may provide an option for the user to locate value(s) for the field(s) in the document. The correct location(s) of the value(s) for the field(s) may be provided back to the metadata management system as positive feedback for the corrected location. The feedback may be aggregated by the metadata management system and summarized to indicate which locations, markers, and document structure was most associated with finding correct value(s) for the field, and which locations, markers, and document structure was most associated with finding incorrect value(s) for the field. The summarized feedback and other metadata may be used to add, to prompt template(s) for the category in which the feedback was provided, aggregate observations about where to look in the documents of that category to find value(s) for certain field(s). The field-specific insights added to the prompt templates from the metadata may allow the LLM to avoid red herrings or incorrect values that would be chosen but for an instruction to ignore them, and to more heavily focus on parts of the document that often contain correctly matched values.

### Outbound Document Transformation

In one embodiment, the document integration system supports extracting documents from a repository for sending to third parties. The extracted documents may or may not be integrated in the database. If the documents are already integrated in the database, fields and values for the extracted documents may be used to construct a format of the document that is expected by a recipient (e.g., UBL or OAG). A recipient may supply an expected format, for example, using a JSON structure or another structure that specifies what structural is needed for the format and where values from the document should be placed in the text. The values from the corresponding fields may be inserted into the structured format according to any specified structure, and, as a result, the document integration system supports integration with any third party system that expects any incoming format.

If the document has not yet been integrated into the database, the document integration system may determine the field(s) and value(s) of the document using a prompt template corresponding to a category of the document according to the techniques described herein. The prompt template may be filled in with optically recognized characters from the document as well as metadata about where field(s) are often found for documents in the category. A large language model may provide the resulting values in a structured format, and the document integration system may insert the values in the structured format into the specified output format expected by the third party. In another embodiment, for outbound documents, the prompt template to request that the large language model provide results in the format expected by the third party rather than or in addition to a structured format consumable by the document integration system.

### Process Automation from Ingested Document Data

In various examples, document data automatically detected from ingested documents may serve as input into process automation logic for triggering actions based on the document data. The process automation logic may include custom rules or policies to tailor a system's functionality, security, and compliance measures to meet specific organizational specifications. The custom rules may be configured and deployed by information technology (IT) professionals or administrators that understand the technical intricacies of an enterprise system using heterogenous data models from different applications to properly configure settings, permissions, and workflows for targeted collaborative results across the different applications. For example, the custom rules may be configured on a canvas that specifies reviewer(s) to be involved in the approval process for expenses having certain characteristics, and an order or sequence of reviewers in certain scenarios. For example, the canvas may allow the custom rules to be dragged around and rearranged with respect to each other, to adjust ordering or change approvals or steps included in certain pathways driven by conditions satisfied by the document, submitting user, value(s) from the document, or other characteristic of the document, document category, or parties involved in the document. The custom rules may also trigger notifications to the submitting user, to reviewing users, and/or to other monitoring users at various times during the workflow, after certain phases of review and/or approval have been met.

In one example, a user orders an item from a vendor in support of a project. The vendor sends a document to the user via an email address registered with the vendor. The document may include images and/or text data, and the images may include images of handwriting, signatures, identifiers, descriptions, amounts, or other values.

In one particular example, an automation workflow detects documents from particular vendors and/or that satisfy certain criteria, and the documents are automatically forwarded to a document handling workflow, such as one associated with a receiving email address or phone number for Short Message Service (SMS) messages. In this particular example, the user does not even need to forward the vendor's email, as the email may be automatically detected as being from a particular vendor and/or matching certain formatting known to be associated with a document from that vendor. The automatic processing of the email may be performed by an automation tool configured to forward information from or about documents matching specified conditions, and the forwarded information from or about documents may be reformatted or forwarded as-is to the document integration system for processing or storing information from or about the document. The automation tool may be dependent on whether the user has a profile or account for the vendor registered with the automation tool, and the rules applied to incoming emails may be configured to apply across a plurality of users such that emails are detected for automatic forwarding on behalf of the plurality of users without individual configuration from each user. The users may disable the automatic forwarding feature or forego registering a profile for the vendor with the automation tool if such automatic forwarding is not desired. In one example, the automatic forwarding may be dependent on one condition that evaluates whether an account identifier or other identifier listed on the document matches a number or partial number (e.g., last 4 digits) of an account identifier in a stored record, and/or another condition that evaluates whether one or more values detected in the document are above or below a threshold. Various conditions may be based on various characteristics of the document or registered profile. The forwarded email may copy the sender so the user who submitted the document can see that the document is in the approval process. If the user already has a trip, report, project, or other grouping opened for document processing, the information from the document may be added to the grouping and trigger any downstream automation configured for the grouping. In one embodiment, the automatic forwarding is initially dependent on whether the user has an open grouping configured to include automatically forwarded emails.

To understand contents of the document, the document integration system may utilize a large language model according to techniques described herein to process contents of the document and determine value(s) such as amount(s), name(s) of entit(ies), description(s), other textual data such as numerical or alphanumerical data, and/or other information discernable from the document. In this particular example, after submitting a document for processing, the user need not be involved in the document integration process to gain a benefit of any downstream automation that results from integrating information from the document. The document may be processed from start to finish, with any necessary approvals being obtained for any downstream processes, if any, all based on the initial email from the submitting user. The user may be notified, via email, SMS message, or otherwise, that the document integration process or any downstream process is occurring on the user's behalf, prompting the user to intervene only if intervention is necessary. For example, the user may intervene if an erroneous document is received from a submitter or the document otherwise violates a policy for document submission, document integration, or downstream processing. In various other examples, the user may have an option to submit any report(s) or manually trigger any downstream process(es) that are based on the document rather than having the report(s) or downstream process(es) fully automated. In these scenarios, the user may review and approve the documents and items based on the documents that were gathered automatically based on email or SMS message intake before submitting them together as a report or approving other downstream automation.

In another particular example, a user forwards an email to a document integration workflow, such as one associated with a receiving email address or phone number for SMS messages. The document integration workflow ingests a document attached to the email and may utilize a large language model according to techniques described herein to process contents of the document and determine field value(s) and/or other information discernable from the document. The document may be processed from the forwarded email to finish, with any necessary approvals being obtained, if any, all based on the forwarded email from the user. The user may be notified, via email, SMS message, or otherwise, that the document integration process or any other downstream process is occurring on the user's behalf, prompting the user to intervene only if intervention is necessary. For example, the user may intervene if an erroneous amount is detected on the document or the document otherwise violates a policy for document submission, integration, or downstream processing. In various other examples, the user may have an option to submit any report(s) or manually trigger any downstream process(es) that are based on the document rather than having the report(s) or downstream process(es) fully automated. In these scenarios, the user may review and approve the documents and items based on the documents that were gathered automatically based on email or SMS message intake before submitting them together as a report or approving other downstream automation.

In various embodiments, certain characteristics of the document and/or field value(s) determined from the document may be weighed together to determine whether automated processing is to be performed or not for the document. For example, a document deliberately reported by action(s) of the user through an official email or text message channel may be treated with higher weight to be processed automatically than an email or text message that is detected by rules and reported automatically by the rules (which would receive a lower weight for automatic processing). As yet another example, a document from a vendor, involving amount, and/or a particular item or type of item regularly involved in documents from that vendor may have a higher weight of being processed automatically than a document not from a regular vendor, involving an amount, and/or a particular type of item regularly involved in documents from the vendor (which would receive a lower weight for automatic processing). A total aggregate weight for automatic processing may be determined across all evidentiary content to determine whether to proceed with automatic processing while looping in the user via email or text message as a notification that the automatic processing is occurring, or to proceed with prompting the user to take action before automatic processing proceeds.

In one embodiment, if the document integration system determines that user input is needed for an otherwise automated document integration workflow, the document integration system may notify the user of feedback needed, adjustments needed, or other action needed from the user in order for the document to resume proceeding automatically through the document integration workflow or for the document to be removed or partially removed from the document integration workflow.

In one embodiment, a document integration system determines whether a detected value is within a threshold allowed for a user who originated a document in which the value was detected. If the value is not within the threshold, the user or another user may be notified via a triggered notification that the value is not within the threshold. For example, an expense or spending limit may have been exceeded by a value detected from a document submitted. If the value is within the threshold, automated processing may proceed.

In one embodiment, a report may be generated or downstream automation may be initiated based on a value detected in a document, and the report or initiated downstream automation may be displayed to a reviewing user such as a manager. The reviewing user may be determined based on the user who originated or submitted the document, for example, based on an approval chain for the user. A notification may be displayed to the reviewing user that the report or downstream automation is available for review, such as approval or rejection of the report or downstream automation. The reviewing user may review the report or downstream automation and select an option to approve or an option to reject the report or downstream automation. Approval of the report or downstream automation may trigger additional review by additional reviewers, or may trigger the automated process to proceed with the downstream automation. Approval or rejection of the report or downstream automation may trigger additional notifications to the submitting/originating user and/or to the reviewing user, to keep the involved users informed of the progress of the report or downstream automation. The notification to review the report or downstream automation, or that the report or downstream automation has been reviewed or approved, may include information about the report or downstream automation such as the field value(s) detected from the document, such as an entity name, a product name, a budget amount, an expense amount, or a supply amount.

The document integration system may include approval analysis tools to suggest to reviewing users whether downstream automation, optionally including report generation, for a document should be approved or rejected. For example, the approval analysis tools may analyze a history of behavior associated with the user who originated the document to determine whether the user typically submits documents that are within limits or policies or not within limits or policies. If the user has a history of submitting documents that are not within limits or policies, the approval analysis tools may flag this history and suggest approving or rejecting the item depending on a relevance of the history to the item being reviewed. Such relevance may be determined, for example, based on a similarity of characteristics of the documents that have been rejected and the document under review. The approval analysis tools may additionally or alternatively account for a history of activity from the reviewing user when suggesting whether to approve or reject an expense. For example, if a reviewing user has rejected downstream automation for documents with similar characteristics in the past, the reviewing user may receive a suggestion to reject the downstream automation along with an explanation that other documents with similar characteristics were also rejected by the reviewing user.

The reviewing user may review proposed downstream automation items in a document integration application accessible to the reviewing user. The document integration application may provide information about documents of different categories and information about different groups of users (e.g., different teams or classes of employees) that have originated or are approved to originate documents for integration.

### Automatically Generated Document Processing Workflows

In one embodiment, a data management system generates a prompt using Retrieval-Augmented Generation (RAG) to request a process automation rule from a large language model (LLM) that accomplishes certain user-specified goals. The LLM may ingest schema information associated with documents, such as how field value(s) are stored, as well as definitions of different available Application Programming Interfaces (APIs) or other invocable logic in the system for triggering actions according to the provided definitions. The generated prompt to the LLM may also include few-shot example pairings of user-specified goals and example commands to invoke logic in the system for triggering actions, to promote few-shot learning by the LLM to produce results consistent with the examples.

In various examples, the prompt generated to the LLM may present examples where the conditions and actions are separately defined to accomplish user-specified goals, as well as a schema or expected structure or organization of data to use for storing conditions and actions that are to be generated by the LLM responsive to the prompt. By storing and representing conditions and actions separately, the prompt may explore more complex conditions and/or actions without having complexities from the requested conditions impacting the LLM-generated actions or complexities from the requested actions impacting the LLM-generated conditions.

Whether workflows are generated automatically or manually via a canvas or other customization interface, the conditions and actions in the workflows may relate to processing of documents through an approvals, analysis, error-checking, notification, reporting, and/or other downstream automation workflow. For example, the conditions may check for new documents from different individuals, from individuals in different groups or with different roles, or for documents associated with certain products, services, locations, entities, trips, activities, events, or other criteria. The actions may trigger requests for approval, which may be queued according to an approval hierarchy. The actions may trigger analysis of downstream automation approved, rejected, or performed to detect patterns, make predictions, and provide results of the analysis to the individual or other individuals at the organization monitoring document intake. The actions may trigger error-checking to ensure that database items created from incoming documents are not duplicated, that document submissions are in-line with the organization's policies, to ensure that documents are stored according to an organization's policies, and to ensure that downstream automation is in line with an organization's policies. Any detected errors may be sent to the submitting individual, a reviewing/approving individual, and/or other individuals at the organization. The actions may trigger notifications to the submitting, reviewing, or approving individual and/or other individuals at the organization. The actions may trigger display or generation of reports, dashboards, or other analytics to the individual and/or other individuals at the organization.

### Example Prompt Templates and LLM Responses

Different expense receipt categories (such as meals, miscellaneous, airfare) may utilize different prompts. In one embodiment, an LLM is used to identify the appropriate expense category.

Below is an example prompt template for the Accommodations category:

```
## Task Description
Extract specific details from the Expense Receipt Text provided below and format the output
as a JSON Object String. No further explanation or Additional Notes are needed in the
Inference
## Guidelines
- **Merchant Name:** Identify the merchant's name from the expense receipt text. If
merchant name is unclear, default Merchant Name to “ ”.
- **Country:** Identify the country name in English where the expense was made, using the
merchant address or merchant name information in the expense receipt text as a reference. If
country name is unclear, default country name to “ ”.
- **Currency:** Identify the currency code used for the payment. If it is unclear, default to
the official currency code of the country where the expense occurred. The output currency
code adheres to ISO 4217 standards.
- **Total Amount:** Extract the numeric total amount charged (As known as Total Due, As
known as Payment Amount) on this expense receipt text. If it is unclear, default the total
amount to 0.
- **Date:** Extract the date the expense receipt was issued. If it is unclear, default Date to “
”.
- **Time:** Extract the time the expense receipt was issued. If it is unclear, default Time to
“ ”.
- **Check In Date:** Identify the accommodation check in date (As known as Arrival Date)
from this expense receipt text. If it is unclear, default Check In Date to “ ”.
- **Check In Time:** Identify the accommodation check in time from this expense receipt
text. If it is unclear, default Check In Time to “ ”.
- **Check Out Date:** Identify the accommodation check out date (As known as Departure
Date) from this expense receipt text. If it is unclear, default Check Out Date to “ ”.
- **Check Out Time:** Identify the accommodation check out time from this expense
receipt text. If it is unclear, default Check Out Time to “ ”.
- **Tip Amount:** Identify the numeric tip amount (As known as Gratuity Amount) from
this expense receipt text. If it is unclear, default the tip amount to 0.
- **Discount Amount:** Identify the numeric discount amount from this expense receipt
text. If it is unclear, default the discount amount to 0.
- **Tax Amount:** Identify the numeric tax amount from this expense receipt text. If it is
unclear, default the tax amount to 0.
- **Payment Method:** Identify the Payment Method from this expense receipt text. Specify
one category from Cash, CreditCard. If it is unclear, default Payment Method to “ ”.
- **Credit Card Number:** Identify the Credit Card Number from this expense receipt text,
last 4 digits only. If it is unclear, default Credit Card Number to “ ”.
- **Credit Card Type:** Identify the Credit Card Type from this expense receipt text. The
available options are VISA, MASTERCARD (also known as MC), AMERICAN EXPRESS
(also known as AMEX or AX). If the credit card type is not explicitly mentioned in the
expense receipt text, classify credit card type as OTHERS.
- **Auth Code:** Identify the authorization code from this expense receipt text. If it is
unclear, default Auth Code to “ ”.
- **Street Address:** Identify the Street Address from this expense receipt text. If it is
unclear, default Street Address to “ ”.
- **City Name:** Identify the City Name from this expense receipt text. If it is unclear,
default City Name to “ ”.
- **State Name:** Identify the State Name (or Province Name) from this expense receipt
text. If it is unclear, default State Name to “ ”.
- **Zip Code:** Identify the Zip Code from this expense receipt text. If it is unclear, default
Zip Code to “ ”.
- **Line Items:** List all the line item charges from the accommodation expense receipt
text. For each item, extract the Date, Description, Charge Amount (numeric only), and Line
Item Type (choose from Room Charge, Room Service Fee, Hotel Restaurant Charge, Credit
Card Payment, Tax Charge, Applied Deposit, Others), maintaining their order. Present this as
a JSON array.
- **Tax Information:** List all tax information from the receipt. For each item, extract the
Description and Amount (numeric only). Present this as a JSON array.
## Example Output Format:
{
  “Merchant Name”: “”,
  “Country”: “”,
  “Currency”: “”,
  “Total Amount”: “”,
  “Date”: “”,
  “Time”: “”,
  “Check In Date”: “”,
  “Check In Time”: “”,
  “Check Out Date”: “”,
  “Check Out Time”: “”,
  “Tip Amount”: “”,
  “Discount Amount”: “”,
  “Tax Amount”: “”,
  “Payment Method”: “”,
  “Credit Card Number”: “”,
  “Credit Card Type”: “”,
  “Auth Code”: “”,
  “Street Address”: “”,
  “City Name”: “”,
  “State Name”: “”,
  “Zip Code”: “”,
  “Line Items”: [
    {“Date”: “”, “Description”: “”, “Charge Amount”: “”, “Line Item Type”: “”}
  ],
  “Tax Information”: [
    {“Description”: “”, “Amount”: “”}
  ]
## Data Used for Inference
##Additional Context
**User Grade**
**User Card Brand**
**DocumentLocation**
**User Location**
### Expense Receipt Text:
“{target_receipt_text}”
### Output:
```

Below is an example prompt template for the Airfare category:

```
## Task Description
Extract specific details from the Expense Receipt Text provided below and format the output
as a JSON Object String. No further explanation or Additional Notes are needed in the
Inference
## Guidelines
- **Merchant Name:** Identify the merchant's name from the expense receipt text. If
merchant name is unclear, default Merchant Name to “ ”.
- **Country:** Identify the country name in English where the expense was made, using the
merchant address or merchant name information in the expense receipt text as a reference. If
country name is unclear, default country name to “ ”.
- **Currency:** Identify the currency code used for the payment. If it is unclear, default to
the official currency code of the country where the expense occurred. The output currency
code adheres to ISO 4217 standards.
- **Total Amount:** Extract the numeric total amount charged (As known as Total Due, As
known as Payment Amount) on this expense receipt text. If it is unclear, default the total
amount to 0.
- **Date:** Extract the date the expense receipt was issued. If it is unclear, default Date to “
”.
- **Time:** Extract the time the expense receipt was issued. If it is unclear, default Time to
“ ”.
- **Start Date:** Identify the air travel trip start(departs) date from this expense receipt text.
If it is unclear, default Start Date to “ ”.
- **Start Time:** Identify the air travel trip start(departs) time from this expense receipt text.
If it is unclear, default Start Time to “ ”.
- **End Date:** Identify the air travel trip end(arrives) date from this expense receipt text. If
it is unclear, default End Date to “ ”.
- **End Time:** Identify the air travel trip end(arrives) time from this expense receipt text.
If it is unclear, default End Time to “ ”.
- **Tip Amount:** Identify the numeric tip amount (As known as Gratuity Amount) from
this expense receipt text. If it is unclear, default the tip amount to 0.
- **Discount Amount:** Identify the numeric discount amount from this expense receipt
text. If it is unclear, default the discount amount to 0.
- **Tax Amount:** Identify the numeric tax amount from this expense receipt text. If it is
unclear, default the tax amount to 0.
- **Payment Method:** Identify the Payment Method from this expense receipt text. Specify
one category from Cash, CreditCard. If it is unclear, default Payment Method to “ ”.
- **Credit Card Number:** Identify the Credit Card Number from this expense receipt text,
last 4 digits only. If it is unclear, default Credit Card Number to “ ”.
- **Credit Card Type:** Identify the Credit Card Type from this expense receipt text. The
available options are VISA, MASTERCARD (also known as MC), AMERICAN EXPRESS
(also known as AMEX or AX). If the credit card type is not explicitly mentioned in the
expense receipt text, classify credit card type as OTHERS.
- **Auth Code:** Identify the authorization code from this expense receipt text. If it is
unclear, default Auth Code to “ ”.
- **Street Address:** Identify the Street Address from this expense receipt text. If it is
unclear, default Street Address to “ ”.
- **City Name:** Identify the City Name from this expense receipt text. If it is unclear,
default City Name to “ ”.
- **State Name:** Identify the State Name (or Province Name) from this expense receipt
text. If it is unclear, default State Name to “ ”.
- **Zip Code:** Identify the Zip Code from this expense receipt text. If it is unclear, default
Zip Code to “ ”.
- **Ticket Number:** Identify the ticket number for the air travel trip from this expense
receipt text. If it is unclear, default Ticket Number to “ ”.
- **Flight Type:** Identify the flight type for the air travel trip from this expense receipt
text. Specify one category from Domestic, International. If it is unclear, default Flight Type
to “ ”.
- **Flight Class:** Identify the flight class type for the air travel trip from this expense
receipt text. Specify one category from Economy, Economy Plus, Business. If it is unclear,
default Flight Class to “ ”.
- **Departure Airport Code:** Identify the departure airport code for the air travel trip from
this expense receipt text. If it is unclear, default Departure Airport Code to “ ”. The output
airport code adheres to IATA airport code standards.
- **Arrival Airport Code:** Identify the arrival airport code for the air travel trip from this
expense receipt text. If it is unclear, default Arrival Airport Code to “ ”. The output airport
code adheres to IATA airport code standards.
## Example Output Format:
{
  “Merchant Name”: “”,
  “Country”: “”,
  “Currency”: “”,
  “Total Amount”: “”,
  “Date”: “”,
  “Time”: “”,
  “Start Date”: “”,
  “Start Time”: “”,
  “End Date”: “”,
  “End Time”: “”,
  “Tip Amount”: “”,
  “Discount Amount”: “”,
  “Tax Amount”: “”,
  “Payment Method”: “”,
  “Credit Card Number”: “”,
  “Credit Card Type”: “”,
  “Auth Code”: “”,
  “Street Address”: “”,
  “City Name”: “”,
  “State Name”: “”,
  “Zip Code”: “”,
  “Ticket Number”: “”,
  “Flight Type”: “”,
  “Flight Class”: “”,
  “Departure Airport Code”: “”,
  “Arrival Airport Code”: “”
}
## Data Used for Inference
##Additional Context
**User Grade**
**User Card Brand**
**DocumentLocation**
**User Location**
### Expense Receipt Text:
“{target_receipt_text}”
### Output:
```

Below is an example prompt template for the Car Rental category:

```
## Task Description
Extract specific details from the Expense Receipt Text provided below and format the output
as a JSON Object String. No further explanation or Additional Notes are needed in the
Inference
## Guidelines
- **Merchant Name:** Identify the merchant's name from the expense receipt text. If
merchant name is unclear, default Merchant Name to “ ”.
- **Country:** Identify the country name in English where the expense was made, using the
merchant address or merchant name information in the expense receipt text as a reference. If
country name is unclear, default country name to “ ”.
- **Currency:** Identify the currency code used for the payment. If it is unclear, default to
the official currency code of the country where the expense occurred. The output currency
code adheres to ISO 4217 standards.
- **Total Amount:** Extract the numeric total amount charged (As known as Total Due, As
known as Payment Amount) on this expense receipt text. If it is unclear, default the total
amount to 0.
- **Date:** Extract the date the expense receipt was issued. If it is unclear, default Date to “
”.
- **Time:** Extract the time the expense receipt was issued. If it is unclear, default Time to
“ ”.
- **Start Date:** Identify the car rental start date from this expense receipt text. If it is
unclear, default Start Date to “ ”.
- **Start Time:** Identify the car rental start time from this expense receipt text. If it is
unclear, default Start Time to “ ”.
- **End Date:** Identify the car rental end date from this expense receipt text. If it is
unclear, default End Date to “ ”.
- **End Time:** Identify the car rental end time from this expense receipt text. If it is
unclear, default End Time to “ ”.
- **Tip Amount:** Identify the numeric tip amount (As known as Gratuity Amount) from
this expense receipt text. If it is unclear, default the tip amount to 0.
- **Discount Amount:** Identify the numeric discount amount from this expense receipt
text. If it is unclear, default the discount amount to 0.
- **Tax Amount:** Identify the numeric tax amount from this expense receipt text. If it is
unclear, default the tax amount to 0.
- **Payment Method:** Identify the Payment Method from this expense receipt text. Specify
one category from Cash, CreditCard. If it is unclear, default Payment Method to “ ”.
- **Credit Card Number:** Identify the Credit Card Number from this expense receipt text,
last 4 digits only. If it is unclear, default Credit Card Number to “ ”.
- **Credit Card Type:** Identify the Credit Card Type from this expense receipt text. The
available options are VISA, MASTERCARD (also known as MC), AMERICAN EXPRESS
(also known as AMEX or AX). If the credit card type is not explicitly mentioned in the
expense receipt text, classify credit card type as OTHERS.
- **Auth Code:** Identify the authorization code from this expense receipt text. If it is
unclear, default Auth Code to “ ”.
- **Street Address:** Identify the Street Address from this expense receipt text. If it is
unclear, default Street Address to “ ”.
- **City Name:** Identify the City Name from this expense receipt text. If it is unclear,
default City Name to “ ”.
- **State Name:** Identify the State Name (or Province Name) from this expense receipt
text. If it is unclear, default State Name to “ ”.
- **Zip Code:** Identify the Zip Code from this expense receipt text. If it is unclear, default
Zip Code to “ ”.
## Example Output Format:
{
  “Merchant Name”: “”,
  “Country”: “”,
  “Currency”: “”,
  “Total Amount”: “”,
  “Date”: “”,
  “Time”: “”,
  “Start Date”: “”,
  “Start Time”: “”,
  “End Date”: “”,
  “End Time”: “”,
  “Tip Amount”: “”,
  “Discount Amount”: “”,
  “Tax Amount”: “”,
  “Payment Method”: “”,
  “Credit Card Number”: “”,
  “Credit Card Type”: “”,
  “Auth Code”: “”,
  “Street Address”: “”,
  “City Name”: “”,
  “State Name”: “”,
  “Zip Code”: “”
}
## Data Used for Inference
##Additional Context
**User Grade**
**User Card Brand**
**DocumentLocation**
**User Location**
### Expense Receipt Text:
“{target_receipt_text}”
### Output:
```

Below is an example prompt template for the Meals category:

```
## Task Description
Extract specific details from the Expense Receipt Text provided below and format the output
as a JSON Object String. No further explanation or Additional Notes are needed in the
Inference
## Guidelines
- **Merchant Name:** Identify the merchant's name from the expense receipt text. If
merchant name is unclear, default Merchant Name to “ ”.
- **Country:** Identify the country name in English where the expense was made, using the
merchant address or merchant name information in the expense receipt text as a reference. If
country name is unclear, default country name to “ ”.
- **Currency:** Identify the currency code used for the payment. If it is unclear, default to
the official currency code of the country where the expense occurred. The output currency
code adheres to ISO 4217 standards.
- **Total Amount:** Extract the numeric total amount charged (As known as Total Due, As
known as Payment Amount) on this expense receipt text. If it is unclear, default the total
amount to 0.
- **Date:** Extract the date the expense receipt was issued. If it is unclear, default Date to “
”.
- **Time:** Extract the time the expense receipt was issued. If it is unclear, default Time to
“ ”.
- **Tip Amount:** Identify the numeric tip amount (As known as Gratuity Amount) from
this expense receipt text. If it is unclear, default the tip amount to 0.
- **Discount Amount:** Identify the numeric discount amount from this expense receipt
text. If it is unclear, default the discount amount to 0.
- **Tax Amount:** Identify the numeric tax amount from this expense receipt text. If it is
unclear, default the tax amount to 0.
- **Number of Guest:** Identify the total number of people for whom the meal was
purchased from this expense receipt text. If it is unclear, default Number of Guest to 0.
- **Payment Method:** Identify the Payment Method from this expense receipt text. Specify
one category from Cash, CreditCard. If it is unclear, default Payment Method to “ ”.
- **Credit Card Number:** Identify the Credit Card Number from this expense receipt text,
last 4 digits only. If it is unclear, default Credit Card Number to “ ”.
- **Credit Card Type:** Identify the Credit Card Type from this expense receipt text. The
available options are VISA, MASTERCARD (also known as MC), AMERICAN EXPRESS
(also known as AMEX or AX). If the credit card type is not explicitly mentioned in the
expense receipt text, classify credit card type as OTHERS.
- **Auth Code:** Identify the authorization code from this expense receipt text. If it is
unclear, default Auth Code to “ ”.
- **Street Address:** Identify the Street Address from this expense receipt text. If it is
unclear, default Street Address to “ ”.
- **City Name:** Identify the City Name from this expense receipt text. If it is unclear,
default City Name to “ ”.
- **State Name:** Identify the State Name (or Province Name) from this expense receipt
text. If it is unclear, default State Name to “ ”.
- **Zip Code:** Identify the Zip Code from this expense receipt text. If it is unclear, default
Zip Code to “ ”.
## Example Output Format:
{
  “Merchant Name”: “”,
  “Country”: “”,
  “Currency”: “”,
  “Total Amount”: “”,
  “Date”: “”,
  “Time”: “”,
  “Tip Amount”: “”,
  “Discount Amount”: “”,
  “Tax Amount”: “”,
  “Number of Guest”: “”,
  “Payment Method”: “”,
  “Credit Card Number”: “”,
  “Credit Card Type”: “”,
  “Auth Code”: “”,
  “Street Address”: “”,
  “City Name”: “”,
  “State Name”: “”,
  “Zip Code”: “”
}
## Data Used for Inference
##Additional Context
**User Grade**
**User Card Brand**
**DocumentLocation**
**User Location**
### Expense Receipt Text:
“{target_receipt_text}”
### Output:
```

Below is an example prompt template for the Miscellaneous category:

```
## Task Description
Extract specific details from the Expense Receipt Text provided below and format the output
as a JSON Object String. No further explanation or Additional Notes are needed in the
Inference
## Guidelines
- **Merchant Name:** Identify the merchant's name from the expense receipt text. If
merchant name is unclear, default Merchant Name to “ ”.
- **Country:** Identify the country name in English where the expense was made, using the
merchant address or merchant name information in the expense receipt text as a reference. If
country name is unclear, default country name to “ ”.
- **Currency:** Identify the currency code used for the payment. If it is unclear, default to
the official currency code of the country where the expense occurred. The output currency
code adheres to ISO 4217 standards.
- **Total Amount:** Extract the numeric total amount charged (As known as Total Due, As
known as Payment Amount) on this expense receipt text. If it is unclear, default the total
amount to 0.
- **Date:** Extract the date the expense receipt was issued. If it is unclear, default Date to “
”.
Time:** Extract the time the expense receipt was issued. If it is unclear, default Time to
“ ”.
- **Tip Amount:** Identify the numeric tip amount (As known as Gratuity Amount) from
this expense receipt text. If it is unclear, default the tip amount to 0.
- **Discount Amount:** Identify the numeric discount amount from this expense receipt
text. If it is unclear, default the discount amount to 0.
- **Tax Amount:** Identify the numeric tax amount from this expense receipt text. If it is
unclear, default the tax amount to 0.
- **Payment Method:** Identify the Payment Method from this expense receipt text. Specify
one category from Cash, CreditCard. If it is unclear, default Payment Method to “ ”.
- **Credit Card Number:** Identify the Credit Card Number from this expense receipt text,
last 4 digits only. If it is unclear, default Credit Card Number to “ ”.
- **Credit Card Type:** Identify the Credit Card Type from this expense receipt text. The
available options are VISA, MASTERCARD (also known as MC), AMERICAN EXPRESS
(also known as AMEX or AX). If the credit card type is not explicitly mentioned in the
expense receipt text, classify credit card type as OTHERS.
- **Auth Code:** Identify the authorization code from this expense receipt text. If it is
unclear, default Auth Code to “ ”.
- **Street Address:** Identify the Street Address from this expense receipt text. If it is
unclear, default Street Address to “ ”.
- **City Name:** Identify the City Name from this expense receipt text. If it is unclear,
default City Name to “ ”.
- **State Name:** Identify the State Name (or Province Name) from this expense receipt
text. If it is unclear, default State Name to “ ”.
- **Zip Code:** Identify the Zip Code from this expense receipt text. If it is unclear, default
Zip Code to “ ”.
- **Subcategory:** Identify the Subcategory from this expense receipt text. Specify one
category from Taxi, Limo, Fuel, Parking & Tolls. If it is unclear, default Subcategory to “ ”.
## Example Output Format:
{
  “Merchant Name”: “”,
  “Country”: “”,
  ‘Currency”: “”,
  “Total Amount”: “”,
  “Date”: “”,
  “Time”: “”,
  “Tip Amount”: “”,
  “Discount Amount”: “”,
  “Tax Amount”: “”,
  “Payment Method”: “”.
  “Credit Card Number”: “”,
  “Credit Card Type”: “”,
  “Auth Code”: “”,
  “Street Address”: “”,
  “City Name”: “”,
  “State Name”: “”,
  “Zip Code”: “”,
  “Subcategory”: “”
}
## Data Used for Inference
##Additional Context
**User Grade**
**User Card Brand**
**DocumentLocation**
**User Location**
### Expense Receipt Text:
“{target_receipt_text}”
### Output:
```

Below is an example prompt template for the Taxi category:

```
## Task Description
Extract specific details from the Expense Receipt Text provided below and format the output
as a JSON Object String. No further explanation or Additional Notes are needed in the
Inference
## Guidelines
- **Merchant Name:** Identify the taxi/ridesharing merchant's name from the expense
receipt text. If merchant name is unclear, default Merchant Name to “ ”.
- **Country:** Identify the country name in English where the expense was made, using the
merchant address or merchant name information in the expense receipt text as a reference. If
country name is unclear, default country name to “ ”.
- **Currency:** Identify the currency code used for the payment. If it is unclear, default to
the official currency code of the country where the expense occurred. The output currency
code adheres to ISO 4217 standards.
- **Total Amount:** Extract the numeric total amount charged (As known as Total Due, As
known as Payment Amount) on this expense receipt text. If it is unclear, default the total
amount to 0.
- **Date:** Extract the date the expense receipt was issued. If it is unclear, default Date to “
”.
** Time:** Extract the time the expense receipt was issued. If it is unclear, default Time to
“ ”.
- **Tip Amount:** Identify the numeric tip amount (As known as Gratuity Amount) from
this expense receipt text. If it is unclear, default the tip amount to 0.
- **Discount Amount:** Identify the numeric discount amount from this expense receipt
text. If it is unclear, default the discount amount to 0.
- **Tax Amount:** Identify the numeric tax amount from this expense receipt text. If it is
unclear, default the tax amount to 0.
- **Payment Method:** Identify the Payment Method from this expense receipt text. Specify
one category from Cash, CreditCard. If it is unclear, default Payment Method to “ ”.
- **Credit Card Number:** Identify the Credit Card Number from this expense receipt text,
last 4 digits only. If it is unclear, default Credit Card Number to “ ”.
- **Credit Card Type:** Identify the Credit Card Type from this expense receipt text. The
available options are VISA, MASTERCARD (also known as MC), AMERICAN EXPRESS
(also known as AMEX or AX). If the credit card type is not explicitly mentioned in the
expense receipt text, classify credit card type as OTHERS.
- **Auth Code:** Identify the authorization code from this expense receipt text. If it is
unclear, default Auth Code to “ ”.
- **Street Address:** Identify the Street Address from this expense receipt text. If it is
unclear, default Street Address to “ ”.
- **City Name:** Identify the City Name from this expense receipt text. If it is unclear,
default City Name to “ ”.
- **State Name:** Identify the State Name (or Province Name) from this expense receipt
text. If it is unclear, default State Name to “ ”.
- **Zip Code:** Identify the Zip Code from this expense receipt text. If it is unclear, default
Zip Code to “ ”.
- **Start Location:** Identify the Rideshare trip's start location address from this expense
receipt text. If it is unclear, use “ ” as the output.
- **End Location:** Identify the Rideshare trip's end location address from this expense
receipt text. If it is unclear, use “ ” as the output.
- **Start Time:** Extract the start time for this ride. If it is unclear, default Time to “ ”.
- **End Time:** Extract the end time for this ride. If it is unclear, default Time to “ ”.
- **Trip Fare:** Identify the numeric trip fare amount from this expense receipt text. Trip
fare refers to the amount charged for the ride itself, excluding additional service fees and
tips. If it is unclear, use “ ” as the output.
## Example Output Format:
{
  “Merchant Name”: “”,
  “Country”: “”,
  “Currency”: “”,
  “Total Amount”: “”,
  “Date”: “”,
  “Time”: “”,
  “Tip Amount”: “”,
  “Discount Amount”: “”,
  “Tax Amount”: “”,
  “Payment Method”: “”,
  “Credit Card Number”: “”,
  “Credit Card Type”: “”,
  “Auth Code”: “”,
  “Street Address”: “”,
  “City Name”: “”,
  “State Name”: “”.
  “Zip Code”: “”,
  “Start Location”: “”,
  “End Location”: “”,
  “Start Time”: “”,
  “End Time”: “”,
  “Trip Fare”: “”
}
## Data Used for Inference
##Additional Context
**User Grade**
**User Card Brand**
**DocumentLocation**
**User Location**
### Expense Receipt Text:
“{target_receipt_text}”
### Output
```

Different example prompts may be used for Structured and Unstructured format in the Remittance Advice Use Case.

Below is an example prompt template for Remittance Advice in Unstructured format:

```
## Task
Please extract the following information from the remittance advice provided by the
customer to the supplier, and return it as key-value pairs in the output format specified. The
supplier is Dropbox.
## Oracle Fusion API StandardReceipt Required Fields with Description
- Amount: The amount paid in the receipt
- ReceiptDate: The date when the payment is received from customer
- Currency: The currency of the payment, must adhere to ISO 4217 standards in 3 letter
currency code format
## Oracle Fusion API RemittanceReferences Array Required Fields with Description
- ReferenceNumber: The original supplier invoice number
- ReferenceAmount: The amount of payment that is being applied to a particular invoice
## Oracle Fusion API StandardReceipt Optional Fields with Description
- CustomerName: The customer business unit name that made the payment
- CustomerSite: The customer's physical address
## Output Format
{
  “Amount”: “source_value”,
  “ReceiptDate”: “source_value”,
  “Currency”: “source_value”,
  “CustomerName”: “source_value”,
  “CustomerSite”: “source_value”,
  “remittanceReferences”: [
    {
      “ReferenceNumber”: “source_value”,
      “ReferenceAmount”: “source_value”
    }
    // Add more remittance references as needed
  ]
}
## Rules
- Return all fields
- Must strictly follow the order specified in the output format
- Return dates in the format found in the data unchanged
- Should the currency is unclear, default to the official currency code of the country where
the payment occurred
- A Remittance Advice may contain more than one remittanceReferences
- Return NULL if field is not found
## Data Extracted from Remittance Advice
{item_description}
```

Below is an example prompt template for Remittance Advice in Structured format:

```
## Task
You are tasked with mapping field names from a Remittance Advice File to Oracle Fusion's
API field names.
## Oracle Fusion API StandardReceipt Required Fields with Description
- Amount: The amount paid in the receipt
- ReceiptDate: The date when the payment is received from customer
- Currency: The currency of the payment, must adhere to ISO 4217 standards in 3 letter
currency code format
## Oracle Fusion API RemittanceReferences Array Required Fields with Description
- ReferenceNumber: The unique identifier that references the original invoice to the customer
- ReferenceAmount: The amount of payment that is being applied to a particular invoice
## Oracle Fusion API StandardReceipt Optional Fields with Description
- CustomerName: The customer business unit name that made the payment
- CustomerSite: The customer location or address
## Output Format
{
  “Amount”: “source_field_name”,
  “ReceiptDate”: “source_field_name”,
  “Currency”: “source_field_name”,
  “CustomerName”: “source_field_name”,
  “CustomerSite”: “source_field_name”,
  “ReferenceNumber”: “source_field_name”,
  “ReferenceAmount”: “source_field name”
}
## Rules
- Return all fields specified in Output Format
- Must strictly follow the order specified in the output format
- Return dates in the format found in the data unchanged
- Return NULL if field is not found
- If the Remittance Advice is in English, do not produce translations
- If the Remittance Advice is not in English, you must provide a JSON mapping of all the
Remittance Advice field names to English translations, separate from the Output Format, and
list the JSON mapping under ‘[Translations]’
## Remittance Advice File
{item_description}
```

### Example Embodiments and Features

In one embodiment, a document type is recognized by the system and transformed to standard format definition. The document type may be determined by heuristics, machine learning, and/or generative AI and contextual details specific to the document type. A fingerprint may be generated for each document using static information specific to the doc type.

Structured documents may use generative AI one or more times to create the transform definition. Using generative AI to create the transform definition provides increased scalability and may reduce costs. In one embodiment, a fingerprint is utilized to apply adaptive learning to the transformation created by generative AI. A transform definition may be stored in the database, keyed on the fingerprint, so that the transform definition may be retrieved without regenerating the transform definition when similar data is encountered in a future document transformation. Unstructured documents may utilize generative AI for both data extraction and transformation. The document integration system may include support for user correction when recognition failures occur.

Predictions may be determined to be a true positive if data is correctly identified to a corresponding field, a true negative if empty fields remain empty, a false positive if a field is populated with incorrect data or an empty field is populated with unexpected data, or a false negative if data is provided in a file but not identified. Accuracy of the data transformation may be determined as:

$$Accuracy = \frac{True Positives + True Negatives}{All Samples}$$

In one embodiment, the document integration system accepts heterogeneous documents like receipts, supplier invoice, bank statements, remittance advice type, external accounting hub transactions, etc. in source format as-is and processes them effectively within an application platform.

Documents can be unstructured, such as PDF or Image or Emails, or structured, such as CSV, XML or XLS documents, etc.

Processing documents in Gen AI may cost money due to the high amount of computing resources consumed. For bulk or volume ingestion, the document mapping may be done once to create a target mapping, and then large volumes of data may be ingested in bulk with that target mapping.

For unstructured formats, Gen AI can be used for runtime transformation of the document where Gen AI adds real value by identifying where in the recognized characters relevant content occurs.

For structured formats, Gen AI can be leveraged to generate a transformation definition and persist the transformation definition for further use with other structured documents in the same format. This transformation may be mapped against the Fingerprint ID of this document.

When a document comes in and a matching transformation is found for its Fingerprint ID, the document integration system uses the transformation from a Data Integration layer to transform the content to a desired format and create the document or generate CSV and upload to a data persistence mechanism such as a content management system (e.g., Universal Content Management (UCM)) or any other data store.

Documents may be fingerprinted based on structure or skeleton. Unstructured documents may be fingerprinted based on labels present on the document, borders, etc. Structure documents may be fingerprinted based on the payload metadata (e.g., keys of XML or JSON attributes, headers of CSV files, etc.) A fingerprint ID is used for finding whether a transformation exists for a given set of attributes identifying a structured document.

If a document transformation (Structured or Unstructured) is not recognized fully for a Source object, a Learning UI is used to allow the user to specify the mapping, and the document integration system learns from the user-selected mapping. The document integration system applies transformations as part of Federated Learning to promote high document recognition accuracy.

In one embodiment, the document integration system provides an ability to bulk upload & mass correct documents (like invoice) along with defaulting for a touch-less experience.

Various embodiments empower customers to train the system for improved document recognition, optimizing image processing efficiency for bulk upload of invoice document processing.

An Adaptive Learning and Enrichment web application may provide a centralized self-service user interface for customers. The solution may accommodate diverse data formats and promote compatibility with various file structures.

In various examples, a user interface includes an example Start/Upload Page, which features a component for uploading invoice bulk invoice files. In the example, the Page displays the uploaded file names within the zip to the user, and shows upload progress indicator while the APIs process the uploaded file and return data.

A user interface may also include an example Review and Annotate Page, which presents multiple tables alongside a PDF viewer positioned, for example, on the right. The tables display values returned by the API (i.e. values extracted from the invoice via image recognition). The user interface allows users to edit table contents for corrections or additional data entry and allows users to train the model by updating table values, either manually or by annotating directly on the PDF. The user interface allows an upload of the annotated data and posts updated values back to the data management system through an API to train the model for recognizing values correctly initially.

In an example file upload user workflow, the data integration system starts by accepting an upload of an invoice file on the Start/Upload Page. After the file is uploaded, the data management system processes data from the file, and the user is navigated to a Review Page upon completion. In a review and edit page, the data management system allows review of the processed data in tables, to make necessary edits, and annotate the PDF for further accuracy. Corrections and additional data from the user are sent back to the data management system for model training, to enhance the learning model to more accurately detect values from the documents.

### Example Document Types

Below are some examples of document types that are handled according to the techniques described herein.

| Doc. | Flow | Type | Format | Format Detail | Potential RAG Sources |
|---|---|---|---|---|---|
| 1 | Partner E-invoices | Inbound | Structured | Public standard | Interface table columns |
| | | | | format in | and definitions |
| | | | | Universal Business | Existing Invoice |
| | | | | Language (UBL)/ | Interface attributes |
| | | | | Official Airline | based Extensible |
| | | | | Guide (OAG)/ | Stylesheet Language |
| | | | | commerce XML | Transformations (XSLT) |
| 2 | Supplier E-invoices | Inbound | Structured | Supplier own | Seeded Customer |
| | | | | format in CSV/ | Managed Keyed (CMK) |
| | | | | XML | transformations for |
| | | | | | public formats in |
| | | | | | XSLT |
| 3 | Supplier Payment | Inbound | Unstructured | PDF/Email | Examples on |
| | Request | | | (Quick Form) | different PDF |
| | | | | | layouts List |
| | | | | | of Values |
| | | | | | (LOVs) of |
| | | | | | extracted |
| | | | | | attributes |
| 4 | | Inbound | Structured | CSV (file-based | |
| | | | | data import | |
| | | | | (FBDI)) | |
| 5 | Payment Formats | Outbound | Structured | CSV | |
| 6 | Lockbox Receipts | Inbound | Structured | CSV | |
| | | | | (Headerless) | |
| 7 | Remittance Advice | Inbound | Unstructured | PDF/Email | Target attribute |
| | | | | | definitions |
| 8 | | | Structured | CSV | |
| 9 | | Outbound | Structured | CSV | |
| 10 | Accounts Payable | Inbound | Structured | CSV/XML | N/A - seeded |
| | Variable Capital | | | | transformations |
| | Company (VCC) | | | | |
| | Statement | | | | |
| 11 | Expenses Receipts/ | Inbound | Unstructured | PDF/Email/ | N/A |
| | Hotel Folios | | | Image | |
| 12 | Supplier Invoices | Inbound | Unstructured | PDF/Email/ | |
| | | | | Image | |
| 13 | Bank Statement | Inbound | Unstructured | PDF | |
| 14 | Customer E-invoices | Outbound | Structured | Public standard | |
| | | | | format in UBL/ | |
| | | | | OAG/cXML | |
| 15 | General Ledger - | Inbound | Structured | CSV | |
| | Preview Accrual Entry | | | | |
| 16 | Collections - | Inbound | Unstructured | Email | |
| | Collector Actions | | | | |
| 17 | Payment Instructions | Outbound | Unstructured | PDF | |

### Agent-Based Document Intake Architecture

In various embodiments, agents of a multi-agent system may perform various aspects of the document integration pipeline, each with access to same or potentially different tools. For example, the type of the document may be determined by a first agent in a multi-agent system that supports communication between agents and communication between individual agents and one or more large language models, and generating a prompt to determine values from the document may be performed by a second agent in the multi-agent system. The second agent may be selected from among a plurality of candidate agents based at least in part on the type of the document, and the first agent may pass the document of that type to the second agent for further processing. In another example, the second agent may be selected from among the plurality of candidate agents based at least in part on an entity detected in the document by an entity detection agent, and the entity detection agent may pass the document involving that entity to the second agent for further processing. In yet another example, the second agent may be selected from among the plurality of candidate agents based at least in part on a formatting of a section detected in the document by a formatting detection agent, and the formatting detection agent may pass the document involving that entity to the second agent for further processing. In yet another example, the second agent may be selected from among the plurality of candidate agents based at least in part on a domain (e.g., finance, expenses, invoices, inbound documents, outbound documents, etc.) detected for the document by a domain detection agent, and the domain detection agent may pass the document involving that domain to the second agent for further processing.

Other agents may be involved in processing detected values, ingesting detected values, checking for validity of detected values, and/or triggering downstream process(es) such as generating report(s) or sending notification(s) to user(s). Each agent may have separate access to the LLM, special-purpose prompt templates, and/or special-purpose tools such as tools that use APIs to access datasets and functionality and that may require authentication such as by using an authentication key or token that may be accessible to the agent but not to other agents. The agents may operate independently of each other but may also communicate with each other using APIs, data streams, or other structured communication.

In one embodiment, the agents are structured into supervising agent(s) and worker agent(s). The supervising agent(s) may analyze incoming document(s) or other data inputs to determine which worker agent(s) should be selected to handle the incoming document(s). The worker agent(s) may be specialized to handle certain type(s) of document(s) or perform certain downstream processing. The supervising agent(s) may also analyze result(s) from the worker agent(s) and/or combine results from many worker agents into a merged result, for example, for downstream processing or data integration purposes.

In various embodiments, agents may include a supervising agent as a document IO agent for inputting and outputting documents. Worker agents may include, for example, a payable invoice assistant, a payables PDF invoice assistant, a payables e-invoice assistant, a payables invoice enrichment assistant, a payables assistant more generally, a document onboarder agent, a document specification and identification agent, a document transformation agent, an inbound document assistant, an outbound document assistant, an assistant specific to a particular partner entity, and/or other assistants specific to document types, formats, or entities. In the examples, the payable invoice assistant may automatically generate mappings for incoming invoices in CSV, XML, and/or JSON formats and also assist users to map the unrecognized attributes to an invoice format of a target database. The payables PDF invoice assistant may recognize the payable invoice information in a PDF invoice from the supplier and allow the payables specialist to review the accuracy of the information and process the invoice quickly and efficiently. The specialist can provide inputs to the agent to correct the recognized information which the agent will learn from and may improve recognition for. The payables e-invoice assistant may accept e-invoices in various formats like XML or JSON, etc., with any data shape and generate mappings to create the invoice in an enterprise resource planning system. The agent may also allow the specialist to review the mappings and provide adjustments or corrections to the generated mappings which the agent may learn from and may improve recognition for. The payable invoice enrichment assistant may enable the transformation specialist to provide various enrichment rules to enrich the data recognized by the document IO agent to create a complete payables invoice in the system that requires minimal changes and have it ready for approval.

In another example, the assistant includes a payable invoice assistant that is able to handle a variety of payable invoice issues such as the payable invoice assistant issues, payables pdf invoice assistant issues, payables e-invoice assistant issues, payable invoice enrichment assistant issues, and payable invoice recognition assistant issues defined above.

The document onboarder agent may help provide information about different channels that are present in the system to send or receive documents and help establish on the fly channels (apart from pre-established channels). The document onboarder agent may also explain what type of documents or business flows are configured on available channels and provide details on what is expected on the channels. The document specification and identification agent may help determine uploaded documents specification (type, which business object the document is for based on its identity, document schema as recognized by the system, etc.) and identified targets available in the system which the incoming document will be transformed to. The document transformation agent may help determine transformation between a source and target specification. The agent may analyze if existing transformations are available based on identifiers of documents as returned by a document specification agent and use the information to proceed with factory transformation and to capture user instructions if factory transformation requires additional action. The transformation worker agent delegates the details of getting the base transformation and overlaying with learnings or user mappings for different business objects using the individual worker agents for those business objects. The generic functionality of combining factory with user overrides is common to the transformation agent.

In yet another example, the assistant includes a document type assistant that is able to handle a variety of types of use cases for a specific document type (pdf, email, image, CSV, XML, JSON, etc.). The assistant may be able to perform each of the types of activities for the corresponding document type.

### Computer System Architecture

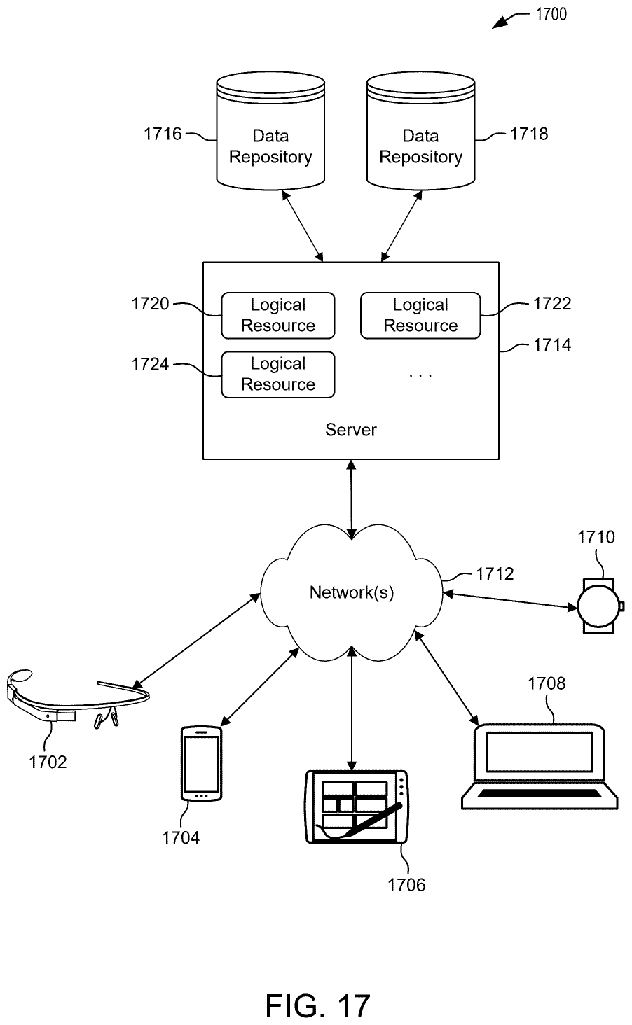

FIG. 17 depicts a simplified diagram of a distributed system 1700 for implementing an embodiment. In the illustrated embodiment, distributed system 1700 includes one or more client computing devices 1702, 1704, 1706, 1708, and/or 1710 coupled to a server 1714 via one or more communication networks 1712. Clients computing devices 1702, 1704, 1706, 1708, and/or 1710 may be configured to execute one or more applications.

In various aspects, server 1714 may be adapted to run one or more services or software applications that enable techniques for using generative AI enriched with metadata about historical document characteristics to transform documents of various formats, including images, to the fields and values they represent.

In certain aspects, server 1714 may also provide other services or software applications that can include non-virtual and virtual environments. In some aspects, these services may be offered as web-based or cloud services, such as under a Software as a Service (SaaS) model to the users of client computing devices 1702, 1704, 1706, 1708, and/or 1710. Users operating client computing devices 1702, 1704, 1706, 1708, and/or 1710 may in turn utilize one or more client applications to interact with server 1714 to utilize the services provided by these components.

In the configuration depicted in FIG. 17, server 1714 may include one or more components 1720, 1722 and 1724 that implement the functions performed by server 1714. These components may include software components that may be executed by one or more processors, hardware components, or combinations thereof. It should be appreciated that various different system configurations are possible, which may be different from distributed system 1700. The embodiment shown in FIG. 17 is thus one example of a distributed system for implementing an embodiment system and is not intended to be limiting.

Users may use client computing devices 1702, 1704, 1706, 1708, and/or 1710 for techniques for submitting documents to trigger a process of using generative AI enriched with metadata about historical document characteristics to transform documents of various formats, including images, to the fields and values they represent in accordance with the teachings of this disclosure. A client device may provide an interface that enables a user of the client device to interact with the client device. The client device may also output information to the user via this interface. Although FIG. 17 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, LinuxR or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch™, and other devices), and the like. The client devices may be capable of executing various different applications such as various Internet-related apps, communication applications (e.g., e-mail applications, short message service (SMS) applications) and may use various communication protocols.

Network(s) 1712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1714 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1714 can include one or more virtual machines running virtual operating systems, or other computing architectures involving virtualization such as one or more flexible pools of logical storage devices that can be virtualized to maintain virtual storage devices for the server. In various aspects, server 1714 may be adapted to run one or more services or software applications that provide the functionality described in the foregoing disclosure.

The computing systems in server 1714 may run one or more operating systems including any of those discussed above, as well as any commercially available server operating system. Server 1714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1714 may include one or more applications to analyze and consolidate data feeds and/or event updates received from users of client computing devices 1702, 1704, 1706, 1708, and/or 1710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1714 may also include one or more applications to display the data feeds and/or real-time events via one or more display devices of client computing devices 1702, 1704, 1706, 1708, and/or 1710.

Distributed system 1700 may also include one or more data repositories 1716, 1718. These data repositories may be used to store data and other information in certain aspects. For example, one or more of the data repositories 1716, 1718 may be used to store information for techniques for using generative AI enriched with metadata about historical document characteristics to transform documents of various formats, including images, to the fields and values they represent. Data repositories 1716, 1718 may reside in a variety of locations. For example, a data repository used by server 1714 may be local to server 1714 or may be remote from server 1714 and in communication with server 1714 via a network-based or dedicated connection. Data repositories 1716, 1718 may be of different types. In certain aspects, a data repository used by server 1714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1716, 1718 may also be used by applications to store application data. The data repositories used by applications may be of different types such as, for example, a key-value store repository, an object store repository, or a general storage repository supported by a file system.

In one embodiment, server 1714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

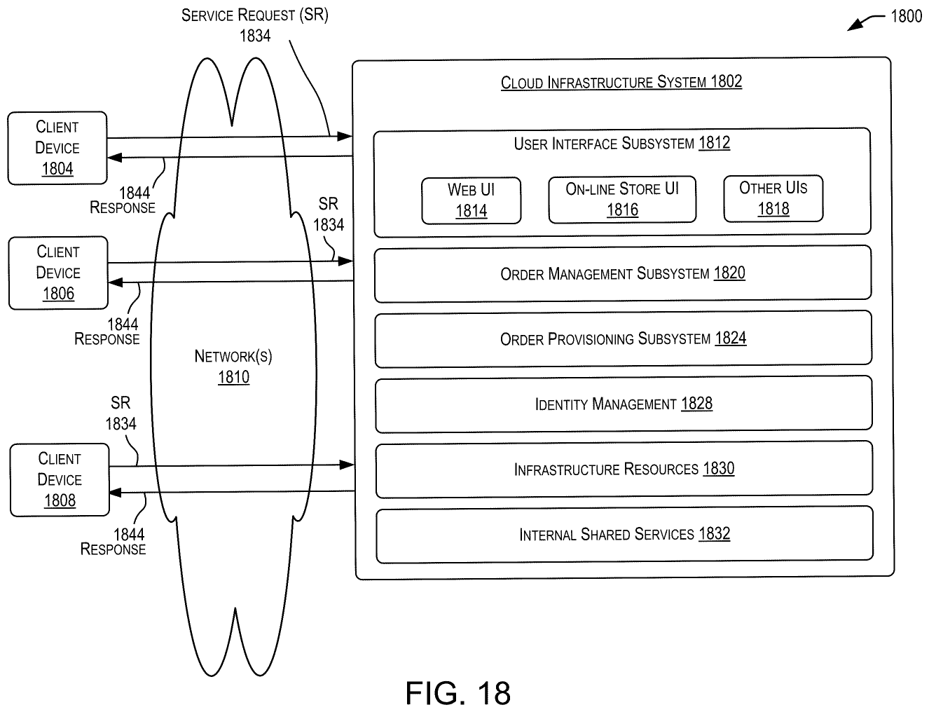

FIG. 18 is a simplified block diagram of a cloud-based system environment in which the cloud infrastructure system 1802 uses generative AI enriched with metadata about historical document characteristics to transform documents of various formats, including images, to the fields and values they represent, in accordance with certain aspects. In the embodiment depicted in FIG. 18, cloud infrastructure system 1802 may provide one or more cloud services that may be requested by users using one or more client computing devices 1804, 1806, and 1808. Cloud infrastructure system 1802 may comprise one or more computers and/or servers that may include those described above for server 1714. The computers in cloud infrastructure system 1802 may be organized as general purpose computers, specialized server computers, server farms, server clusters, or any other appropriate arrangement and/or combination.

Network(s) 1810 may facilitate communication and exchange of data between clients 1804, 1806, and 1808 and cloud infrastructure system 1802. Network(s) 1810 may include one or more networks. The networks may be of the same or different types. Network(s) 1810 may support one or more communication protocols, including wired and/or wireless protocols, for facilitating the communications.

The embodiment depicted in FIG. 18 is only one example of a cloud infrastructure system and is not intended to be limiting. It should be appreciated that, in some other aspects, cloud infrastructure system 1802 may have more or fewer components than those depicted in FIG. 18, may combine two or more components, or may have a different configuration or arrangement of components. For example, although FIG. 18 depicts three client computing devices, any number of client computing devices may be supported in alternative aspects.

The term cloud service is generally used to refer to a service that is made available to users on demand and via a communication network such as the Internet by systems (e.g., cloud infrastructure system 1802) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1802 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1802. Cloud infrastructure system 1802 then performs processing to provide the services requested in the tenant's subscription order. Cloud infrastructure system 1802 may be configured to provide one or even multiple cloud services.

Cloud infrastructure system 1802 may provide the cloud services via different deployment models. In a public cloud model, cloud infrastructure system 1802 may be owned by a third party cloud services provider and the cloud services are offered to any general public tenant, where the tenant can be an individual or an enterprise. In certain other aspects, under a private cloud model, cloud infrastructure system 1802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1802 and the services provided may be shared by several organizations in a related community. Various other models such as hybrids of the above mentioned models may also be used.

Client computing devices 1804, 1806, and 1808 may be of different types (such as devices 1702, 1704, 1706, and 1708 depicted in FIG. 17) and may be capable of operating one or more client applications. A user may use a client device to interact with cloud infrastructure system 1802, such as to request a service provided by cloud infrastructure system 1802.

In some aspects, the processing performed by cloud infrastructure system 1802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 18, cloud infrastructure system 1802 may include infrastructure resources 1830 that are utilized for facilitating the provision of various cloud services offered by cloud infrastructure system 1802. Infrastructure resources 1830 may include, for example, processing resources, storage or memory resources, networking resources, and the like.

In certain aspects, to facilitate efficient provisioning of these resources for supporting the various cloud services provided by cloud infrastructure system 1802 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1802 may itself internally use services 1832 that are shared by different components of cloud infrastructure system 1802 and which facilitate the provisioning of services by cloud infrastructure system 1802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1802 may comprise multiple subsystems. These subsystems may be implemented in software, or hardware, or combinations thereof. As depicted in FIG. 18, the subsystems may include a user interface subsystem 1812 that enables users of cloud infrastructure system 1802 to interact with cloud infrastructure system 1802. User interface subsystem 1812 may include various different interfaces such as a web interface 1814, an online store interface 1816 where cloud services provided by cloud infrastructure system 1802 are advertised and are purchasable by a consumer, and other interfaces 1818. For example, a tenant may, using a client device, request (service request 1834) one or more services provided by cloud infrastructure system 1802 using one or more of interfaces 1814, 1816, and 1818. For example, a tenant may access the online store, browse cloud services offered by cloud infrastructure system 1802, and place a subscription order for one or more services offered by cloud infrastructure system 1802 that the tenant wishes to subscribe to. The service request may include information identifying the tenant and one or more services that the tenant desires to subscribe to. For example, a tenant may place a subscription order for a chatbot related service offered by cloud infrastructure system 1802. As part of the order, the client may provide information identifying the input (e.g. utterances).

In certain aspects, such as the embodiment depicted in FIG. 18, cloud infrastructure system 1802 may comprise an order management subsystem (OMS) 1820 that is configured to process the new order. As part of this processing, OMS 1820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1820 may then invoke the order provisioning subsystem (OPS) 1824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1802 may send a response or notification 1844 to the requesting tenant to indicate when the requested service is now ready for use. In some instances, information (e.g., a link) may be sent to the tenant that enables the tenant to start using and availing the benefits of the requested services.

Cloud infrastructure system 1802 may provide services to multiple tenants. For each tenant, cloud infrastructure system 1802 is responsible for managing information related to one or more subscription orders received from the tenant, maintaining tenant data related to the orders, and providing the requested services to the tenant or clients of the tenant. Cloud infrastructure system 1802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1802 may provide services to multiple tenants in parallel. Cloud infrastructure system 1802 may store information for these tenants, including possibly proprietary information. In certain aspects, cloud infrastructure system 1802 comprises an identity management subsystem (IMS) 1828 that is configured to manage tenant's information and provide the separation of the managed information such that information related to one tenant is not accessible by another tenant. IMS 1828 may be configured to provide various security-related services such as identity services, such as information access management, authentication and authorization services, services for managing tenant identities and roles and related capabilities, and the like.

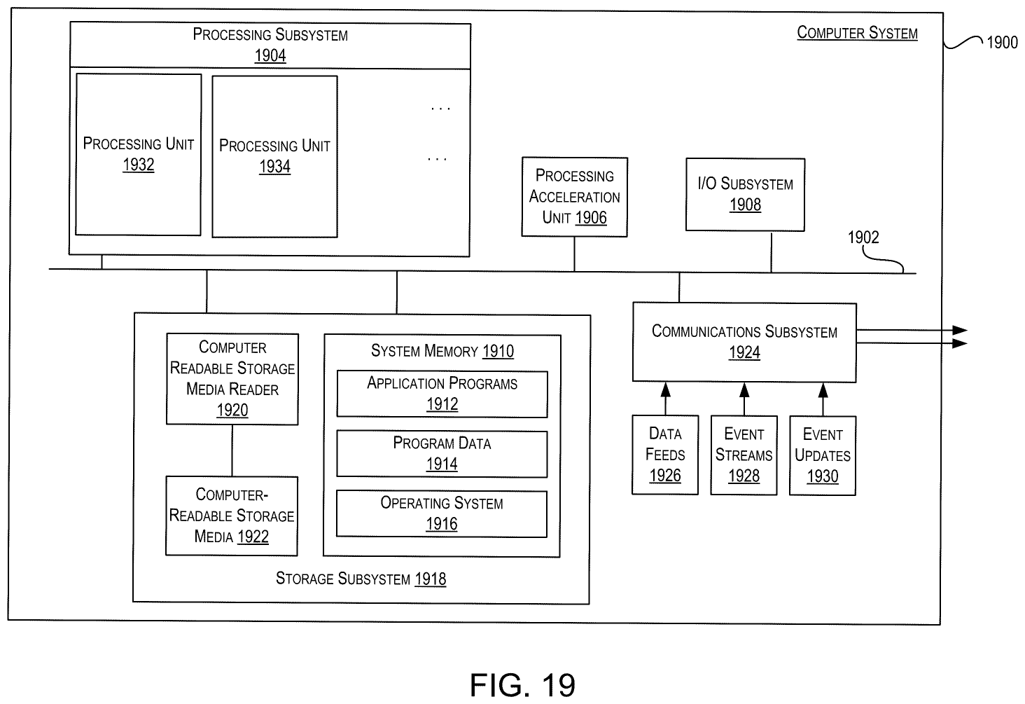

FIG. 19 illustrates an exemplary computer system 1900 that may be used to implement certain aspects. As shown in FIG. 19, computer system 1900 includes various subsystems including a processing subsystem 1904 that communicates with a number of other subsystems via a bus subsystem 1902. These other subsystems may include a processing acceleration unit 1906, an I/O subsystem 1908, a storage subsystem 1918, and a communications subsystem 1924. Storage subsystem 1918 may include non-transitory computer-readable storage media including storage media 1922 and a system memory 1910.

Bus subsystem 1902 provides a mechanism for letting the various components and subsystems of computer system 1900 communicate with each other as intended. Although bus subsystem 1902 is shown schematically as a single bus, alternative aspects of the bus subsystem may utilize multiple buses. Bus subsystem 1902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1904 controls the operation of computer system 1900 and may comprise one or more processors, application specific integrated circuits (ASICs), or field programmable gate arrays (FPGAs). The processors may be single core or multicore processors. The processing resources of computer system 1900 can be organized into one or more processing units 1932, 1934, etc. A processing unit may include one or more processors, one or more cores from the same or different processors, a combination of cores and processors, or other combinations of cores and processors. In some aspects, processing subsystem 1904 can include one or more special purpose co-processors such as graphics processors, digital signal processors (DSPs), or the like. In some aspects, some or all of the processing units of processing subsystem 1904 can be implemented using customized circuits, such as application specific integrated circuits (ASICs), or field programmable gate arrays (FPGAs).

In some aspects, the processing units in processing subsystem 1904 can execute instructions stored in system memory 1910 or on computer readable storage media 1922. In various aspects, the processing units can execute a variety of programs or code instructions and can maintain multiple concurrently executing programs or processes. At any given time, some or all of the program code to be executed can be resident in system memory 1910 and/or on computer-readable storage media 1922 including potentially on one or more storage devices. Through suitable programming, processing subsystem 1904 can provide various functionalities described above. In instances where computer system 1900 is executing one or more virtual machines, one or more processing units may be allocated to each virtual machine.

In certain aspects, a processing acceleration unit 1906 may optionally be provided for performing customized processing or for off-loading some of the processing performed by processing subsystem 1904 so as to accelerate the overall processing performed by computer system 1900.

I/O subsystem 1908 may include devices and mechanisms for inputting information to computer system 1900 and/or for outputting information from or via computer system 1900. In general, use of the term input device is intended to include all possible types of devices and mechanisms for inputting information to computer system 1900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1918 provides a repository or data store for storing information and data that is used by computer system 1900. Storage subsystem 1918 provides a tangible non-transitory computer-readable storage medium for storing the basic programming and data constructs that provide the functionality of some aspects. Storage subsystem 1918 may store software (e.g., programs, code modules, instructions) that when executed by processing subsystem 1904 provides the functionality described above. The software may be executed by one or more processing units of processing subsystem 1904. Storage subsystem 1918 may also provide a repository for storing data used in accordance with the teachings of this disclosure.

Storage subsystem 1918 may include one or more non-transitory memory devices, including volatile and non-volatile memory devices. As shown in FIG. 19, storage subsystem 1918 includes a system memory 1910 and a computer-readable storage media 1922. System memory 1910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1900, such as during start-up, may typically be stored in the ROM. The RAM typically contains data and/or program modules that are presently being operated and executed by processing subsystem 1904. In some implementations, system memory 1910 may include multiple different types of memory, such as static random access memory (SRAM), dynamic random access memory (DRAM), and the like.

By way of example, and not limitation, as depicted in FIG. 19, system memory 1910 may load application programs 1912 that are being executed, which may include various applications such as Web browsers, mid-tier applications, relational database management systems (RDBMS), etc., program data 1914, and an operating system 1916. By way of example, operating system 1916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android™ OS, and others.

Computer-readable storage media 1922 may store programming and data constructs that provide the functionality of some aspects. Computer-readable media 1922 may provide storage of computer-readable instructions, data structures, program modules, and other data for computer system 1900. Software (programs, code modules, instructions) that, when executed by processing subsystem 1904 provides the functionality described above, may be stored in storage subsystem 1918. By way of example, computer-readable storage media 1922 may include non-volatile memory such as a hard disk drive, a magnetic disk drive, an optical disk drive such as a CD ROM, digital video disc (DVD), a Blu-Ray® disk, or other optical media. Computer-readable storage media 1922 may include, but is not limited to, ZipR drives, flash memory cards, universal serial bus (USB) flash drives, secure digital (SD) cards, DVD disks, digital video tape, and the like. Computer-readable storage media 1922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1918 may also include a computer-readable storage media reader 1920 that can further be connected to computer-readable storage media 1922. Reader 1920 may receive and be configured to read data from a memory device such as a disk, a flash drive, etc.

In certain aspects, computer system 1900 may support virtualization technologies, including but not limited to virtualization of processing and memory resources. For example, computer system 1900 may provide support for executing one or more virtual machines. In certain aspects, computer system 1900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1900. Accordingly, multiple operating systems may potentially be run concurrently by computer system 1900.

Communications subsystem 1924 provides an interface to other computer systems and networks. Communications subsystem 1924 serves as an interface for receiving data from and transmitting data to other systems from computer system 1900. For example, communications subsystem 1924 may enable computer system 1900 to establish a communication channel to one or more client devices via the Internet for receiving and sending information from and to the client devices. For example, the communications subsystem may be used to transmit a response to a user regarding the inquiry for a chatbot.

Communications subsystem 1924 may support both wired and/or wireless communication protocols. For example, in certain aspects, communications subsystem 1924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1924 can provide wired network connectivity (e.g., Ethernet) in addition to or instead of a wireless interface.

Communications subsystem 1924 can receive and transmit data in various forms. For example, in some aspects, in addition to other forms, communications subsystem 1924 may receive input communications in the form of structured and/or unstructured data feeds 1926, event streams 1928, event updates 1930, and the like. For example, communications subsystem 1924 may be configured to receive (or send) data feeds 1926 in real-time from users of social media networks and/or other communication services such as Twitter feeds, Facebook& updates, web feeds such as Rich Site Summary (RSS) feeds, and/or real-time updates from one or more third party information sources.

In certain aspects, communications subsystem 1924 may be configured to receive data in the form of continuous data streams, which may include event streams 1928 of real-time events and/or event updates 1930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1924 may also be configured to communicate data from computer system 1900 to other computer systems or networks. The data may be communicated in various different forms such as structured and/or unstructured data feeds 1926, event streams 1928, event updates 1930, and the like to one or more databases that may be in communication with one or more streaming data source computers coupled to computer system 1900.

Computer system 1900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1900 depicted in FIG. 19 is intended only as a specific example. Many other configurations having more or fewer components than the system depicted in FIG. 19 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
receiving a document representing content comprising text;
determining a type of the document based at least in part on similarities between a first plurality of values of a plurality of features of the text and other pluralities of values of the plurality of features stored in association with types of documents, wherein metadata is stored in association with the type of document to indicate where in the type of document certain fields of text have been detected;
selecting a prompt template associated with the type of the document, and generating a prompt comprising the text, one or more field definitions for two or more fields to be detected in the text, one or more indications, based on the metadata, indicating where in the type of document values for at least one of the two or more fields have been historically detected, and a requested structured format of a result;
prompting a large language model with the prompt;
receiving a particular result of the prompt, wherein particular values for the two or more fields are included in the requested structured format of the particular result;
determining where, in the text, at least one particular value of the at least one of the two or more fields were detected;
updating the metadata based at least in part on where, in the text, the at least one particular value was detected;
storing the particular values for the two or more fields in one or more data structures, optionally in association with the document.

2. The computer-implemented method of claim 1, wherein other types of documents are associated with other prompt templates that each include at least one field definition different than the one or more field definitions.

3. The computer-implemented method of claim 1, further comprising receiving input that indicates another location, in the document, that another particular value is detected, wherein the other particular value is labeled as a corrected replacement of the at least one particular value, and updating the metadata based at least in part on the other location.

4. The computer-implemented method of claim 1, wherein determining the type of the document comprises determining cosine distances between the first plurality of values of a plurality of features of the text and other pluralities of values of the plurality of features stored in association with types of documents.

5. The computer-implemented method of claim 1, wherein determining the type of the document comprises prompting a large language model using a document type template to generate a document type prompt, wherein the document type prompt specifies the types of documents and includes the text, the computer-implemented method further comprising receiving a document type response to the document type prompt, wherein the document type response comprises the type of the document.

6. The computer-implemented method of claim 1, wherein at least one type of document of the types of documents is specific to an entity that originated the document.

7. The computer-implemented method of claim 1, wherein the prompt and the metadata indicate where, in the document, values for the at least one field have been historically detected based at least in part on a specified marker that was detected in historical documents.

8. The computer-implemented method of claim 1, wherein the prompt and the metadata indicate where, in the document, values for the at least one field have been historically detected based at least in part on a specified section that was detected in historical documents.

9. The computer-implemented method of claim 1, further comprising causing concurrent display of the document and the at least one particular value in a user interface, wherein the at least one particular value is selectable to cause navigation in the document to a location where the at least one particular value was detected.

10. The computer-implemented method of claim 9, further comprising receiving user input on the document marking another location in the particular document for the at least one particular value, wherein the other location is used to update the metadata.

11. The computer-implemented method of claim 1, wherein the document is received as an attachment to an email.

12. The computer-implemented method of claim 1, wherein the document is received via a Short Message Service text message.

13. The computer-implemented method of claim 1, further comprising initiating a downstream workflow for the document based at least in part on the at least one particular value of the at least one of the two or more fields satisfying a stored condition.

14. The computer-implemented method of claim 1, wherein at least determining the type of the document is performed by a first agent in a multi-agent system that supports communication between agents and communication between individual agents and one or more large language models; and wherein at least generating the prompt is performed by a second agent in the multi-agent system; the computer-implemented method further comprising selecting the second agent from among a plurality of candidate agents based at least in part on the type of the document.

15. The computer-implemented method of claim 1, wherein at least determining the type of the document is performed by a first agent in a multi-agent system that supports communication between agents and communication between individual agents and one or more large language models; and wherein at least generating the prompt is performed by a second agent in the multi-agent system; the computer-implemented method further comprising selecting the second agent from among a plurality of candidate agents based at least in part on an entity detected in the document.

16. The computer-implemented method of claim 1, wherein at least determining the type of the document is performed by a first agent in a multi-agent system that supports communication between agents and communication between individual agents and one or more large language models; and wherein at least generating the prompt is performed by a second agent in the multi-agent system; the computer-implemented method further comprising selecting the second agent from among a plurality of candidate agents that are available to handle the type of the document based at least in part on a formatted section detected in the document.

17. A computer-program product comprising one or more non-transitory machine-readable storage media, including stored instructions configured to cause a computing system to perform a set of actions including:
receiving a document representing content comprising text;
determining a type of the document based at least in part on similarities between a first plurality of values of a plurality of features of the text and other pluralities of values of the plurality of features stored in association with types of documents, wherein metadata is stored in association with the type of document to indicate where in the type of document certain fields of text have been detected;
selecting a prompt template associated with the type of the document, and generating a prompt comprising the text, one or more field definitions for two or more fields to be detected in the text, one or more indications, based on the metadata, indicating where in the type of document values for at least one of the two or more fields have been historically detected, and a requested structured format of a result;
prompting a large language model with the prompt;
receiving a particular result of the prompt, wherein particular values for the two or more fields are included in the requested structured format of the particular result;
determining where, in the text, at least one particular value of the at least one of the two or more fields were detected;
updating the metadata based at least in part on where, in the text, the at least one particular value was detected;
storing the particular values for the two or more fields in one or more data structures, optionally in association with the document.

18. The computer-program product of claim 17, wherein determining the type of the document comprises prompting a large language model using a document type template to generate a document type prompt, wherein the document type prompt specifies the types of documents and includes the text, the set of actions further including receiving a document type response to the document type prompt, wherein the document type response comprises the type of the document.

19. A system comprising:
one or more processors;
one or more non-transitory computer-readable media storing instructions, which, when executed by the system, cause the system to perform a set of actions including:
receiving a document representing content comprising text;
determining a type of the document based at least in part on similarities between a first plurality of values of a plurality of features of the text and other pluralities of values of the plurality of features stored in association with types of documents, wherein metadata is stored in association with the type of document to indicate where in the type of document certain fields of text have been detected;
selecting a prompt template associated with the type of the document, and generating a prompt comprising the text, one or more field definitions for two or more fields to be detected in the text, one or more indications, based on the metadata, indicating where in the type of document values for at least one of the two or more fields have been historically detected, and a requested structured format of a result;
prompting a large language model with the prompt;
receiving a particular result of the prompt, wherein particular values for the two or more fields are included in the requested structured format of the particular result;
determining where, in the text, at least one particular value of the at least one of the two or more fields were detected;
updating the metadata based at least in part on where, in the text, the at least one particular value was detected;
storing the particular values for the two or more fields in one or more data structures, optionally in association with the document.

20. The system of claim 19, wherein determining the type of the document comprises prompting a large language model using a document type template to generate a document type prompt, wherein the document type prompt specifies the types of documents and includes the text, the set of actions further including receiving a document type response to the document type prompt, wherein the document type response comprises the type of the document.
